(19) United States
(12) Patent Application Publication
(10) Pub. No.: US 2008/0280003 A1
(43) Pub. Date: Nov. 13, 2008

(54) Batter-Like Compositions and Methods of Preparing and Using Same

(76) Inventors: Heide C. Coyle, Prior Lake, MN (US); Linda Baggio, Hopkins, MN (US); Douglas G. Boldon, New Hope, MN (US); Laura M. Hansen, White Bear Lake, MN (US); Norrain E. Norsby, Plymouth, MN (US); Timothy M. Trainor, Albertville, MN (US)

Correspondence Address: GENERAL MILLS, INC., P.O. BOX 1113, MINNEAPOLIS, MN, 55440, US

(21) Appl. No.: 11/997,360

(22) PCT Filed: Aug. 3, 2006
(86) PCT No.: PCT/US06/30309

§ 371 Date: Jan. 30, 2008

Related U.S. Application Data
(60) Provisional application No. 60/705,116, filed on Aug. 3, 2005.

(51) Int. Cl. A21D 10/04

(52) U.S. Cl. 426/553

(57) ABSTRACT

The invention provides batter-like compositions including flour or flour replacement ingredient, sweetener, a fat source, and a chemical leavening system, wherein at least a portion of the fat source is provided as an emulsion to the batter-like composition. The resulting batter-like compositions are capable of being formed into discrete product pieces (such as pucks), and maintaining the puck form throughout storage and handling of the batter-like composition prior to baking. The invention further provides methods of preparing batter-like compositions having a discrete form, and methods of using such inventive batter-like compositions to provide baked goods.

### FIELD OF THE INVENTION

The invention relates to farinaceous batter-like compositions. The invention further relates to methods of making such batter-like compositions, as well as intermediate products prepared from such compositions, and baked goods made from such batter-like compositions.

### BACKGROUND OF THE INVENTION

Certain moist baked goods such as muffins, pancakes, cakes, brownies, and the like are typically made from scratch or from a dry mix, where consumers make a batter by adding liquids to dry ingredients and then bake the batter soon after mixing. While these methods can produce high quality baked goods, preparation of the batters can be time consuming. Moreover, the batter should be used by the consumer immediately to provide for optimum leavening action and because the batters are not microbiologically stable under refrigerated conditions.

Some of these issues have been overcome by preparing muffins from frozen muffin batters, wherein the consumer thaws and then bakes the batter. These batters have a slightly lower water activity (A_{w}) than batters prepared from scratch or dry mixes. Additionally, these batters can be stored for about 48 hours under refrigerated conditions after thawing, while maintaining leavening and microbial stability properties. Given the relatively short storage life of the batter once thawed, if the entire batch is not used relatively quickly, there is the risk that the unused portion of the batter will spoil and be wasted.

There exist some premixed refrigerated doughs, such as bread dough, cookie dough, and the like. These doughs typically need to be hermetically sealed, stored under pressure, and/or placed in modified atmosphere packaging (MAP), in order to provide good shelf stability properties under refrigerated storage conditions. As a result, after the consumer opens the packaging for initial use of the product, the refrigerated dough cannot be stored for long periods of time.

### SUMMARY OF THE INVENTION

Generally, the invention provides batter-like compositions comprising flour, sweetener, a fat component, a leavening system, and water. The inventive batter-like compositions comprise an emulsion that includes at least a portion of the fat source. Use of the inventive emulsions has surprisingly provided the ability to form and maintain discrete, non-flowable intermediate farinaceous product pieces for storage and use by a consumer, as described in detail herein. The invention thus provides novel batter-like compositions that possess some of the desirable features of conventional batters (particularly when the batter-like compositions are exposed to baking temperatures), yet provide a product format that is non-flowable at temperatures below baking temperatures.

In some aspects, the invention also provides intermediate farinaceous products that are formed from the batter-like compositions. According to these aspects, the intermediate farinaceous products are in the form of discrete, non-flowable units that can maintain a desired form and be handled by a consumer, even when the intermediate farinaceous product warms to temperatures above typical refrigeration temperatures. When used to describe the intermediate farinaceous products, the phrase “discrete units,” refers to portions of the inventive composition that possess a definite, non-flowable and individual form, as compared to indefinite length materials intended to be divided from one another at a subsequent time after preparation and packaging (for example, at the point of use, upon removal of the batter-like composition from storage for baking). The discrete units can be any defined size of batter-like composition that can be individually stored (although multiple discrete units can be packaged together, as described herein).

Typically, the dimensions and/or shape of the discrete units is (are) selected based upon the final baked good to be prepared from the batter-like composition. For purposes of illustrating the shape of the inventive products, the discrete units will be referred to as “puck” shaped intermediate farinaceous product units (or intermediate product pucks). The “puck” shaped intermediate farinaceous product units generally have a round shape, such as what a hockey puck possesses. These discrete units can be removed from storage and baked as individual units (for example, to provide muffins or other such baked goods), or combined to provide larger baked products (for example, to provide cakes, coffee cakes, quick breads, or other such baked goods). Unlike traditional “puck” products, however, the inventive intermediate farinaceous products do not require a liner to maintain the shape of the product. Rather, the inventive intermediate products provide a discrete, non-flowable shape that can be retained during handling and storage, until application of elevated temperatures relative to ambient (such as baking temperatures). As discussed herein, “ambient” temperatures generally refers to temperatures in the range of about 65° F. to about 85° F. (about 18.3° C. to about 29.4° C.).

Unlike conventional batters, the intermediate farinaceous products of the invention are non-flowable and can maintain a discrete shape and/or structure at temperatures below typical baking temperatures. For purposes of discussing the inventive compositions relative to such conventional batters, compositions in accordance with the invention are referred to as “batter-like.” This phrase is meant to connote compositions that are non-flowable and capable of maintaining a discrete shape and/or structure at temperatures above storage temperatures (e.g., room temperature and/or below baking temperatures). Conventional batters are typically pourable at room temperature. In contrast, the inventive compositions are non-pourable at such temperatures. At the same time, however, the inventive compositions can possess some features that are comparable to conventional batters, such as water absorption, total moisture content, water activity, and/or pH. The inventive compositions can prepare baked goods possessing a cakey texture that historically has only been achievable from conventional, pourable batters. Despite these similarities to conventional batters (and in particular, the amount of water contained in the compositions), the inventive batter-like compositions can tie up water within the composition in a manner that provides structural features (non-flowable characteristics even at temperatures above storage temperatures) heretofore unachievable with conventional batters. The invention thus provides novel systems and compositions for providing baked products that typically result from flowable batters, while providing improved handling features that have not been possible with such flowable batters.

The inventive batter-like compositions can be formed into intermediate farinaceous products that can be stored at refrigeration and/or frozen temperatures. For example, farinaceous products (such as pucks) can be shipped frozen and stored frozen prior to use. Alternatively, the pucks can be shipped frozen, stored frozen, and then refrigerated prior to use. Furthermore, the inventive intermediate farinaceous products can be shipped refrigerated, stored frozen, and then placed in an oven and baked without an intermediate thawing (or slacking) step.

In some aspects, the batter-like compositions can be formed into intermediate farinaceous products that can be stored at frozen temperatures. The inventive farinaceous pucks are capable of maintaining structural integrity at frozen temperatures (that is, temperatures less than about 30° F. (−1.1° C.), or less than about 0° F. (−17.8° C.), or less than about −10° F. (−23.3° C.), providing the consumer with the ability to prepare as few or as many portions as desired, then placing the remainder of the farinaceous pucks back into the freezer without risk of spoilage.

Optionally, the batter-like compositions can be formed into intermediate farinaceous products that can provide freezer-to-oven (“FTO”) frozen intermediate products. In these embodiments, the frozen farinaceous pucks can be baked without thawing or slacking. In some aspects, the inventive FTO intermediate products can be baked without the need for one or more steps of: partially baking the intermediate products prior to freezing, thawing the frozen intermediate products between freezing and baking, and/or slacking the intermediate products between freezing and baking.

After being frozen, intermediate farinaceous products can be thawed at temperatures in the range of about 30° F. (−1.1° C.) to about ambient temperature, or in the range of about 35° F. (1.7° C.) to about 45° F. (7.2° C.), or in the range of about 38° F. (3.3° C.) to about 42° F. (5.6° C.).

Alternatively, the batter-like compositions can be formed into intermediate farinaceous products that can be stored at refrigeration temperatures in the range of about 30° F. (−1.1° C.) to about ambient temperature, or in the range of about 35° F. (1.7° C.) to about 45° F. (7.2° C.), or in the range of about 38° F. (3.3° C.) to about 42° F. (5.6° C.).

The batter-like compositions can provide desirable baked products that are similar to those prepared either from scratch from conventional batters or from dry mixes. Preferred batter-like compositions of the invention can have a density in the range of about 0.40 g/cc (grams per cubic centimeter) to about 1.3 g/cc, or about 0.65 g/cc to about 1.2 g/cc, at temperatures below freezing temperatures. Illustrative density of the batter-like compositions below freezing temperatures can be in the range of about 0.8 g/cc to about 1.2 g/cc. As discussed herein, the inventive compositions can be utilized to prepare a wide variety of baked products; thus, one of skill in the art will readily appreciate that the density of the batter-like compositions can vary widely, depending upon the baked product to be prepared.

The inventive batter-like compositions are typically useful for preparing chemically-leavened farinaceous batter products. Baked products that can be prepared from the inventive batter-like compositions can include, for example, muffins, pancakes, brownies, cakes, coffee cakes, quick breads, corn breads, funnel cakes, and the like.

In some method aspects, the invention provides methods of preparing batter-like compositions comprising steps of:
(a) combining a fat source and water;
(b) heating and mixing the fat source and water to provide an emulsion;
(c) cooling the emulsion to a temperature in the range of about 40° F. to about 200° F. (4.4° C. to about 93.3° C.); and
(d) combining the emulsion with a batter-like base comprising flour or flour replacement ingredient, sweetener, and water to form a batter-like composition having a water activity of less than about 0.94. The invention also provides batter-like compositions prepared in accordance with these methods.

In further aspects, the invention provides methods for preparing intermediate farinaceous products comprising steps of:
(a) combining a fat source and water;
(b) heating and mixing the fat source and water to provide an emulsion;
(c) cooling the emulsion to a temperature in the range of about 40° F. to about 200° F. (4.4° C. to about 93.3° C.);
(d) combining the emulsion with a batter-like base comprising flour or flour replacement ingredient, sweetener, and water to provide a batter-like composition having a total moisture content in the range of about 20% to about 40%; and
(e) forming the batter-like composition into discrete, non-flowable product units. The invention also provides intermediate farinaceous products prepared in accordance with these methods.

In yet further aspects, the invention provides packaged farinaceous products comprising:
(a) a package comprising a plurality of material sheets contained within a package design; and
(b) a plurality of individual farinaceous products positioned on each material sheet,

wherein the farinaceous products comprise flour or flour replacement ingredient, sweetener, fat source, and a chemical leavening system, and a total moisture content in the range of about 20% to about 40%, and

wherein the farinaceous products possess a consistency in the range of about 100 FU to about 1100 FU, when the batter-like composition is at temperatures below about 42° F. (5.6° C.), and a consistency of less than about 100 FU when heated to temperatures above about 42° F. (5.6° C.).

In further aspects, the invention provides batter-like compositions comprising:
(a) a structure providing amount of flour or flour replacement ingredient;
(b) sweetener in an amount effective to provide a water activity of less than about 0.94;
(c) fat source; and
(d) a chemical leavening system,

wherein the batter-like composition retains its original discrete shape at temperatures above about 42° F. (5.6° C.), and

wherein the batter-like composition includes less than about 0.4% gelatin, or less than about 0.35%, or less than about 0.3% by weight. In these aspects, the inventive batter-like compositions can manage a high water content within the batter-like composition without use of a gelling agent such as gelatin to assist in such water management.

In other aspects, the invention provides batter-like compositions comprising:
(a) a structure providing amount of flour replacement ingredient, the flour replacement ingredient comprising native starch in an amount of about 70% by weight or more, and a protein source in an amount of about 30% by weight or less, weight percentages based upon weight of the flour replacement ingredient;
(b) sweetener in an amount effective to provide a water activity of less than about 0.94;
(c) fat source; and
(d) a chemical leavening system,

wherein the batter-like composition retains its original discrete shape at temperatures above about 42° F. (5.6° C.).

The invention further provides batter-like compositions comprising:
(a) a structure providing amount of flour or flour replacement ingredient;
(b) sweetener in an amount effective to provide a water activity of less than about 0.94;
(c) fat source; and
(d) a chemical leavening system,

wherein the batter-like composition retains its original discrete shape at temperatures above about 42° F. (5.6° C.), and wherein the chemical leavening system comprises dimagnesium phosphate trihydrate as a major acidic leavening agent, in combination with a basic leavening agent.

For purposes of illustration, use of the inventive compositions and methods to prepare muffins will be described in detail. Muffins have been selected because these baked goods are typically prepared from dry mixes or from scratch; thus, the advantages of handling and preparation efficiency resulting from the invention can be easily illustrated. Moreover, consumers have certain expectations of muffin products, such as soft, moist product texture and acceptable baked specific volume. Thus, these systems provide the ability to describe the desirable organoleptic properties of baked goods prepared from the inventive batter-like compositions and systems.

These and other aspects and advantages will now be described in more detail.

### BRIEF DESCRIPTION OF THE DRAWINGS

The accompanying drawings, which are incorporated in and constitute a part of this specification, illustrate several aspects of the invention and together with the description of the various embodiments, serve to explain the principles of the invention. A brief description of the drawings is as follows:

FIG. 1 is a farinogram illustrating the consistency of a batter-like composition prepared in accordance with some aspects of the invention (Sample 1 of Examples), wherein time (minutes) is represented along the X-axis, and farinogram units (FU) is represented along the Y-axis.

FIG. 2 is a farinogram illustrating the batter consistency of a comparative sample (Sample 2 of Examples), wherein time (minutes) is represented along the X-axis, and farinogram units (FU) is represented along the Y-axis.

FIG. 3 is a farinogram illustrating the batter consistency of a comparative sample (Sample 3 of Examples), wherein time (minutes) is represented along the X-axis, and farinogram units (FU) is represented along the Y-axis.

FIG. 4 is a farinogram illustrating the dough consistency of a dough comparative sample (Sample 4 of Examples), wherein time (minutes) is represented along the X-axis, and farinogram units (FU) is represented along the Y-axis.

FIG. 5 is a graph illustrating the dynamic mechanical analysis of various samples, wherein temperature (° C.) is represented along the X-axis, and probe position (mm) is represented on the Y-axis.

### DETAILED DESCRIPTION OF THE INVENTION

The embodiments of the invention described below are not intended to be exhaustive or to limit the invention to the precise forms disclosed in the following detailed description. Rather, the embodiments are chosen and described so that others skilled in the art can appreciate and understand the principles and practices of the invention.

Throughout the specification and claims, percentages are by weight and temperatures in degrees Fahrenheit unless otherwise indicated.

As used typically in the industry, the term “dough” refers to an intermediate food product that has a gluten based structure. In dough, the gluten forms a continuous dough elastic medium into which other ingredients can be embedded. A dough is typically prepared by beating, blending, cutting, and/or kneading, and is often stiff enough to cut into various shapes. Doughs typically are used for low sugar-to-flour ratio products such as breads, biscuits, and the like.

In contrast, “batter” refers to an intermediate food product that essentially contains flour, water, and salt, and optionally fat, eggs, and sweetener(s). In a batter, gluten development is purposefully minimized. In general, batters are understood to be less viscous than doughs and to have more free water present. Batters are typically inelastic. Liquid added to make the batter forms a continuous batter medium in which other ingredients can be dispersed. A batter cooks into a soft, moist and sometimes crumbly product. A batter is typically prepared by blending, creaming, stirring, and/or whipping, and is generally flowable enough to pour or scoop or squeeze out of a container.

As used herein, discussion of the density of the batter-like composition (the “raw density”) will refer to the density of the batter-like composition after it has been mixed. The density of the batter-like composition is typically measured prior to baking, and can be measured either after formation of intermediate product (such as pucks) and prior to freezing, or after being taken from frozen storage conditions and at least partially thawed. In contrast, the “baked specific volume” refers to the specific volume of the product after it has been baked, for example, to provide a muffin or cake.

The inventive batter-like compositions can be stored at refrigeration and/or frozen temperatures. Reference to the general phrase “storage temperatures” herein will be understood to encompass both refrigeration and frozen storage conditions.

In some aspects, the batter-like compositions are formulated to be stored at frozen temperatures. The inventive batter-like compositions are capable of maintaining structural integrity at frozen temperatures (that is, temperatures less than about 30° F. (−1.1° C.), or less than about 0° F. (−17.8° C.), or less than about −10° F. (−23.3° C.)), providing the consumer with the ability to prepare as few or as many portions as desired, then placing the remainder of the batter-like composition or intermediate product back into the freezer without risk of spoilage.

In some aspects, the batter-like compositions are stable for at least 30 days, or at least 60 days, or at least 90 days, or at least 120 days, or at least 180 days when stored under frozen conditions. In some aspects, the batter-like compositions are stable for about 6 months at freezing temperatures. Storage temperature may vary throughout storage time. In these aspects, “stable” refers to a batter-like composition that is capable of withstanding at least one freeze/thaw cycle, wherein a freeze/thaw cycle comprises a temperature fluctuation of the batter-like composition between about 32° F. (0° C.) and about 50° F. (10° C.). The stable batter-like compositions are suitable for storage at freezing temperatures without the batter-like composition breaking down by, for example, microbial growth, water accumulation, failure of the leavening agent(s), and the like, and becoming unsuitable for consumption.

After being frozen, intermediate products of the invention can be thawed at temperatures in the range of about 30° F. (−1.1° C.) to about ambient temperature, or in the range of about 35° F. (1.7° C.) to about 45° F. (7.2° C.), or in the range of about 38° F. (3.3° C.) to about 42° F. (5.6° C.).

Optionally, the batter-like compositions can be formulated to provide freezer-to-oven (“FTO”) frozen compositions and/or products. As used herein, the phrase “freezer-to-oven” is meant to indicate that the batter-like compositions of the invention can advantageously proceed directly from a substantially frozen state to a heated environment for cooking without an intervening step that would be sufficient to at least partially thaw the batter-like composition. In these embodiments, the frozen batter-like compositions can be baked without thawing. In some aspects, the inventive FTO batter-like compositions can be baked without the need for one or more steps of: partially baking the batter-like composition prior to freezing, thawing the frozen batter-like composition between freezing and baking, and/or slacking the batter-like composition between freezing and baking. The batter-like compositions can be capable of sufficient expansion upon cooking, thereby producing final baked products with desirable visual and organoleptic properties. In alternative embodiments, the batter-like compositions can be formulated to include a slacking step prior to baking (such as allowing the composition to gradually increase in temperature). Whether the FTO compositions include a slacking step or not, the invention provides batter-like compositions that can be formed into intermediate farinaceous products that are capable of maintaining a discrete shape until the intermediate products reach a desired temperature (for example, baking temperatures).

As discussed herein, the inventive intermediate products (such as pucks) retain identity as discrete, non-flowable units until the products reach a desired temperature. The desired temperature can be an elevated temperature relative to ambient temperatures, for example, about 150° F. (65.6° C.) or greater, or about 200° F. (93.3° C.) or greater, or about 300° F. (148.9° C.) or greater. In some aspects, the desired temperature is referred to herein as a “baking temperature.” The baking temperature will vary, depending upon the baked product to be prepared. For example, for muffins, the baking environment is an oven, and the baking temperature is typically about 350° F. (176.7° C.) to about 400° F. (204.4° C.). For pancakes and waffles, the baking environment is a griddle or other hot surface, and the baking temperatures are typically about 375° F. (190.6° C.). Suitable baking temperatures will depend a great deal on the oven characteristics, the intermediate piece size and baking pan characteristics.

The inventive intermediate products are non-flowable at temperatures below the baking temperatures. In these aspects, the invention provides intermediate products that have a consistency above about 100 FU, or above about 150 FU, or above about 200 FU at temperatures below baking temperatures, or at refrigeration temperatures (approximately 32° F. (0° C.) to 42° F. (5.6° C.)). In some aspects, the consistency of the intermediate farinaceous products is less than that of a conventional dough. In some embodiments, the consistency of the batter-like compositions and/or the intermediate farinaceous products of the invention is between that typically observed for conventional batters and conventional doughs.

In some embodiments, the batter-like compositions are formulated to be stored at refrigeration temperatures in the range of about 30° F. (−1.1° C.) to about ambient temperature, or in the range of about 35° F. (1.7° C.) to about 45° F. (7.2° C.), or in the range of about 38° F. (3.3° C.) to about 42° F. (5.6° C.).

The inventive batter-like compositions include conventional batter ingredients, that is, at least flour, sweetener, a fat component, leavening system, and water. According to the invention, the inventive batter-like compositions include an emulsion system that allows the batter-like composition to be formed into discrete, non-flowable product units (intermediate farinaceous products) that can maintain a desired form and be handled by a consumer, even when the product warms from storage temperatures. Unlike conventional batters, the inventive batter-like compositions can form intermediate products that maintain a discrete shape and size at refrigeration, frozen, and/or room (ambient) temperatures.

According to the invention, the batter-like compositions include a grain constituent that contributes to the structure of the batter-like composition. A variety of different flours can be used as the grain constituent, and different flours can be selected to give a variety of textures, tastes, and appearances to the final baked product.

Useful flours include, but are not limited to, hard wheat flour, soft wheat flour, corn flour, high amylose flour, rice flour, and low amylose flour. The relative proportions of the types of flours used can be varied as desired.

The batter-like compositions typically include an amount of flour effective to provide structure to the batter-like composition. That is, a batter-like composition includes flour in an amount effective to provide desired consistency. Generally speaking, the amount of flour should not be so high that the batter-like composition is dry and loses its ability to expand. However, the amount of flour should not be so low that the batter-like composition is unsuitably soft and loses its structure as a discrete unit. The inventive batter-like compositions generally contain flour in the range of about 20 to about 40 weight percent, or in the range of about 22 to about 35 weight percent, or in the range of about 22 to about 27 weight percent.

Conventionally, flour is standardized to about 14% moisture. One way to characterize flour is by the protein content. Useful flour(s) can be of conventional type and quality, including cake flour, bread flour, and all-purpose flour. Wheat flour can be useful. In some aspects, other flours conventionally used in the preparation of baked goods can be employed in full or partial substitution of the wheat flour. Traditional cake flour used for layer cakes has about 8% or less protein by weight of the flour. Pastry flour ordinarily has a protein level of about 10%. Other flours such as bread flour generally have higher protein levels in the range of about 11% to about 13% by weight. Optionally, flours can be supplemented with a protein supplement such as gluten, for example, when the protein content of the flour is lower than desired. The use of a protein supplement will often be determined based upon the desired total protein content of the batter-like composition.

In some embodiments, the wheat flour useful to make the inventive batter-like compositions has a protein content in the range of about 7% to about 10% by weight of the flour. An all-purpose flour can also be used. Such all-purpose flour generally comprises a mixture of both hard and soft wheat flours (both high protein level and low protein level flours). Such flours are useful if the average protein content is in the range of about 7% to about 10% by weight.

Both chlorinated and unchliorinated flours can be used in accordance with the invention. Selection of chlorinated and/or unchlorinated can depend upon the final application of the batter-like composition. Enzyme inactivated flours can also be utilized. Enriched flours can also be utilized.

In some aspects, the inventive batter-like compositions can be formulated to include a flour-replacement ingredient. One illustrative flour-replacement ingredient is described in PCT Application No. PCT/US06/18423 (Li et al., “Batter Compositions and Methods of Preparing and Using Same,” filed May 10, 2006). In these embodiments, the flour replacement ingredient can comprise native starch and protein. Optional ingredients include modified starch and/or fiber. The flour replacement ingredient can provide properties to a batter-like composition formed therefrom that were conventionally supplied by the flour ingredient in farinaceous products. At the same time, however, it has been found that the flour replacement ingredient can, in some embodiments, avoid undesirable properties that can be present when flour is present in the formulation, such as undesirable enzymatic reactions.

For such flour replacement ingredients, useful native starch includes, but is not limited to, wheat starch, corn starch, potato starch, tapioca starch or a combination of any of these. In accordance with the invention, native starch is the major component of the flour replacement ingredient, comprising about 70% by weight or more, or about 75% by weight or more, or about 80% by weight or more, of the flour replacement ingredient. As used herein, “native starch” refers to starch recovered in the original form (i.e., unmodified) by extraction from any starch-bearing material. Native starch can be contrasted to modified starch, which has undergone physical or chemical modification.

Optionally, a minor amount of modified starch can be included in the flour replacement ingredient. Modified starch can be included, for example, to modify the viscosity of the overall batter-like composition. Typically, the amount of modified starch included in the flour replacement ingredient is on the order of about 25% or less, or about 20% or less, or about 15% or less, or about 10% or less, or about 5% or less, based on weight of the flour replacement ingredient. In other aspects, the modified starch can be present in the flour replacement ingredient in an amount of about 5% or less, or about 4% or less, or about 3% or less, or about 2% or less or about 1% or less by weight, based on total weight of the batter-like composition. As used herein, “modified starch” means that the structure of starch has been modified chemically, thermally, or by other means developed in the future. Such modification can be performed to alter the viscosity of starch in water. One type of modification is gelatinization (thereby forming pregelatinized starch).

For the flour replacement ingredients, suitable protein sources include, for example, gluten, wheat protein, vegetable protein, sodium caseinate, or gelatin, as well as dairy proteins such as milk protein, whey protein and the like, and combinations of any of these. The protein source can be present in an amount of about 30% by weight or less, or about 20% by weight or less, or about 15% by weight or less, based on total weight of the flour replacement ingredient. In some aspects, the protein source can be present in an amount of about 8% by weight or less, or about 7% or less, or about 6% or less, or about 5% or less, or about 3% or less, based on total weight of the overall batter-like composition.

It will be readily appreciated that batter-like compositions can often include protein from other sources (i.e., from sources apart from the flour replacement ingredient). For example, protein can be included in batter-like compositions generally in the form of dairy protein, egg protein, wheat protein, or combinations thereof. Illustrative dairy proteins include whey, soy protein, caseinate, buttermilk, milk solids, buttermilk solids, and nonfat dry milk. Illustrative egg proteins include albumin. The egg component can be present as liquid eggs, typically pasteurized liquid eggs or frozen whole eggs. The pasteurized liquid eggs or frozen whole eggs can provide desirable structuring, emulsification, and/or nutritional benefits to the inventive batter compositions. Pasteurized liquid eggs can also provide at least a portion of the total moisture of the batter-like compositions. Useful amounts of liquid eggs include up to about 30% by weight (based upon the total weight of the batter composition), or in the range of about 1% to about 20%, or about 5% to about 18%. It will be appreciated that liquid eggs comprise about 75% moisture. In some embodiments, the liquid eggs can be replaced in whole or in part with dried eggs solids, or egg fractions in solid form (for example, egg yolk solids and egg white solids). Illustrative wheat proteins include those derived from flour or gluten. In some aspects, the additional protein is selected from caseinate, albumin, whey protein concentrate, nonfat dry milk, buttermilk, or a combination of any two or more of these.

Thus, in some aspects, the invention provides batter-like compositions including a flour replacement ingredient as described herein, wherein the flour replacement ingredient includes a protein source in an amount of about 8% by weight or less, or about 7% or less, or about 6% or less, or about 5% or less, or about 3% or less, based on total weight of the overall batter-like composition. The batter-like composition can include protein from other sources, for example, in an amount up to about 50% by weight (for example, in angel food cakes), or up to about 40% by weight, or up to about 30% by weight, or up to about 20% by weight, or up to about 10% by weight, based upon total weight of the batter-like composition. In these aspects, then, the total protein content of the batter-like compositions (including protein from the flour replacement ingredient and other protein sources external to the flour replacement ingredient) can be up to about 60% by weight, based upon total weight of the batter-like formulation.

Optionally, the flour replacement ingredient can include a fiber source. Useful fiber sources include, for example, wheat fiber, gum, vegetable gums such as alginates, carrageenan, dextran, furcellaran, pectin, gelatin, gum agar, locust bean gum, gum ghatti, guar gum, gum tragacanth, acacia, gum arabic, xanthan gum, karaya gum, tara gum, cellulose derivatives; soluble and insoluble dietary fiber, wood pulp cellulose, seed husks, oat hulls, citrus fiber, pea fiber, corn bran, soy polysaccharide, oat bran, wheat bran, barley, rice bran, gellan gum, or a combination of any of these.

When included, the fiber source can be present in an amount of about 20% by weight or less, or about 15% by weight or less, or about 10% by weight or less, or about 5% by weight or less, based on weight of the flour replacement ingredient. In some aspects, the fiber source can be present in an amount of about 5% or less by weight, or about 4% or less, or about 3% or less, based on total weight of the overall batter composition.

In one exemplary embodiment, the flour replacement ingredient can comprise native starch in an amount of about 70% by weight or more, and a protein source in an amount of about 30% by weight or less, weight percentages based upon weight of the flour replacement ingredient. Optionally, a minor amount of flour can be included in these embodiments, for example, for organoleptic purposes (e.g., in amounts of about 5% or less).

The batter-like compositions can include an amount of flour replacement ingredient effective to provide structure to the batter-like composition. Put another way, a batter-like composition includes flour replacement ingredient in an amount effective to provide desired consistency of the batter-like composition. Generally speaking, the amount of flour replacement ingredient should not be so high that the batter-like composition is dry and loses its ability to expand. However, the amount of flour replacement ingredient should not be so low that the batter-like composition is unsuitably soft and loses its structure as a batter composition. The inventive batter-like compositions generally contain an amount of flour replacement ingredient substantially equal to, or slightly less than, the amount of flour that would be included in a conventional batter composition. To this end, the inventive batter-like compositions can contain flour replacement ingredient in the range of about 12 to about 40 weight percent, or in the range of about 17 to about 35 weight percent, or in the range of about 20 to about 25 weight percent of the batter-like composition.

According to the invention, a sweetener ingredient is included in the inventive batter-like compositions. The sweetener typically comprises sugar or nutritive carbohydrate sweetener ingredients. Generally, the sweetener can provide sweetness and lower the water activity (A_{w}) of the batter-like composition. The inventive batter-like compositions can include one or more sweeteners; thus, reference to the singular form will be understood to include situations where more than one sweetener is included in the inventive compositions.

In some aspects, the sweetener comprises sugar. Useful sugars include saccharides that can reduce the amount of free water in the composition. Useful sugars include monosaccharides, disaccharides, polysaccharides, and their various degradation products. Illustrative sugars include, but are not limited to, pentoses, xylose, arabinose, glucose, galactose, amylose, fructose, sorbose, lactose, maltose, dextrose, sucrose, maltodextrins, high fructose corn syrup (HFCS), molasses and brown sugar. In some embodiments, the sugar is selected from sucrose, high fructose corn syrup, and maltodextrin.

Because the sweeteners impart sweetness to the baked product, the kind and amount of sweetener(s) is (are) selected to achieve a balance between reducing the water activity of the batter-like composition a sufficient amount to provide microbial stability and obtaining the desired degree and quality of sweetness in the baked product. This can be achieved by balancing both the ratios of various sweeteners to one another and the ratios of sweeteners to water in the batter-like composition.

A useful amount of sweetener in a batter-like composition of the present invention includes an amount that provides suitable properties such as sweetness to the batter-like composition, and/or a desired water activity. When reference is made herein to the total amount of sweetener, such amount includes sweetener from all sources. Thus, in some aspects, the invention contemplates batter-like compositions having more than one type of sweetener. Such an amount of total sweeteners can be in the range of about 5% to about 55% by weight of the batter-like composition, or in the range of about 10% to about 40% by weight, the weight percentages based upon the total weight of the batter-like composition.

Another way to characterize a useful amount of sweetener in the inventive batter-like compositions is to observe the relative amount of sweetener to flour. The weight ratio of sweetener to flour is commonly referred to as the baker's ratio. The particular baker's ratio will depend upon various factors, such as, for example, the particular sweetener(s) employed, the final food product, desired baked good attributes, and the like. The baker's ratio of the batter-like compositions can be in the range of about 0.5:1 to about 2.5:1, that is about 1 part sweetener to one part flour, to about 2½ parts sweetener to one part flour. In some embodiments, the sweetener to flour ratio of the inventive batter-like compositions is in the range of about 0.5:1 to about 2:1. Maintenance of the sweetener to flour ratio within these ranges can, in some aspects, be important to providing finished baked goods having the desired eating qualities. In some aspects, the sweetener-to-flour ratio can also impact storage stability of the inventive batter-like compositions.

In some embodiments, at least a portion of the sweetener can be substituted with a high potency heat tolerant sweetener. In some aspects, inclusion of the high potency sweetener can provide additional sweetness to the final baked product. In some aspects of the invention, a high potency sweetener is a component that provides a sweet taste to the final product, where the component contributes no calories or where the component does contribute calories, but possesses a sweetness potency that is so high that their extremely low usage level imparts no significant impact on the final product's caloric content. In some embodiments, the high potency sweetener is selected so as not to degrade during either storage or more importantly, during the baking step. While degradation during storage and baking can be overcome by over fortifying with a high potency sweetener to compensate for the expected loss, such extra addition is costly. One illustrative high potency heat tolerant sweetener is sucralose. The sucralose can be conveniently added in a 25% solution. Good results are obtained when the sucralose is added at about 0.05% to about 0.15%. Other illustrative high potency sweeteners include polydextrose, aspartame, potassium acetylsulfame, saccharine, cyclamate, neotame, alitame, and combinations of any two or more of these. Sugar alcohols that can be utilized include isomalt, lactitol, maltitol, mannitol, sorbitol, erythritol, xylitol, glycerol/glycerin, and combinations of any two or more of these.

In some aspects, at least a portion of the sweetener can comprise a high potency sweetener. In some aspects, therefore, up to 100% of the sweetener can comprise a high potency sweetener. When the inventive compositions include one or more high potency sweeteners, the total amount of sweetener included in the composition is typically decreased. Thus, in embodiments where the compositions include high potency sweetener, the sweetener can comprise up to about 40% of the total batter-like composition, or in the range of about 0.01% to about 40% of the batter-like composition. As a result, one of skill in the art will readily appreciate that bulking agents can be included to compensate for lost weight within the overall composition. Suitable bulking agents include any inert ingredients that do not impact overall textural qualities of the baked product. Illustrative bulking agents include crude fiber that can be composed of cellulose, hemicellulose, lignin, and pectin substances; starches, flour, whey, and the like.

The inventive batter-like compositions can include an edible fat component. A fat component can add richness to the eating properties of the finished baked goods. A fat component can also impact characteristics of the batter-like composition and intermediate product (such as handling and firmness), as well as characteristics of the final baked good (such as texture). The fat component can have beneficial effects on the volume, grain, and texture of the final product, as well as the texture, mouthfeel and/or other organoleptic properties of the baked good.

Useful fat components include shortenings and oils. Animal or vegetable based natural shortenings can be used, as can synthetic shortenings or oils.

Typical shortenings include fatty glyceridic materials that can be classified on the basis of their physical state at room temperature. Solid shortenings are useful and can provide the advantage of desirable mouthfeel upon consumption. In some embodiments, mixtures of liquid and solid shortenings can be utilized. Such mixes can be fluid or plastic, depending in part upon the level of solid fatty materials.

The solid fatty glycerides can include fatty mono-glycerides and diglycerides of saturated fatty acids having 4 to 22 carbon atoms. The liquid shortening can be animal, vegetable or synthetic oil (such as sucrose polyesters) which is liquid at ordinary room temperatures. Representative of such typical fat sources are palm oil, butter, lard, tallow, coconut oil, palm kernel oil, cottonseed oil, peanut oil, olive oil, sunflower seed oil, sesame seed oil, corn oil, safflower oil, poppy seed oil, soybean oil, canola (rapeseed) oil, babassue oil, and the like and combinations thereof. Other suitable shortening materials and methods of shortening preparation are described in detail in Bailey, “Industrial Oil and Fat Products,” (3^{rd} ed. 1964).

Mixtures of the oils described herein can also be used, as can solid fatty materials, such as saturated triglyceride fats. In general, such solid fatty materials can be added to liquid oil, in an amount in the range of about 1.5% to about 25% of triglycerides that are solid at 70° F. (21.1° C.).

In some aspects, at least a portion of the total fat component present in the batter-like composition is included in an emulsion. In some embodiments, the fat component present in the emulsion is a blend of solid and liquid fat components. Such a blend has been observed to provide desirable texture for certain baked goods, such as muffins. The particular amounts of solid and/or liquid fat components present in the emulsion can be determined based upon the particular baked good to be provided. For example, if a more coarse and drier baked product is desired, a larger amount of solid fat relative to liquid fat component can be utilized. In some embodiments, the fat component of the batter-like composition can comprise solid fat alone. It has been observed that inclusion of some liquid fat component can soften the crumb of the baked good and provide a finer texture to the baked good. In still further embodiments, the fat component present in the emulsion can comprise all or substantially all liquid fat. The particular physical state of the fat component in the emulsion, as well as the ratio of solid to liquid fats (when blends are included), can be determined by one of skill in the art upon review of the present disclosure.

In some aspects of the invention, any fat component present outside the emulsion of the batter-like composition can serve as a processing aid. In some embodiments, for example, a liquid oil is added to the batter-like compositions as a component separate from the emulsion during processing. In some aspects of these embodiments, the fat component can be present as a liquid. Some processing benefits can be realized from inclusion of such liquid fats as a separate component from the emulsion.

A useful amount of total fat component in a batter-like composition of the present invention (from all sources) includes an amount that provides suitable properties such as organoleptic qualities and desired textural properties to the finished baked good. Such an amount can be up to about 25% of the batter-like composition, or in the range of about 10% to about 20% by weight. For preparation of a lower fat baked good, the batter-like compositions can include total fat in an amount up to about 10%, or in the range of about 1% to about 10% by weight, based upon the total weight of the batter-like composition.

Optionally, the inventive batter-like compositions can include a fat-replacer, for instance, when it is desired to provide a baked product having less fat. Suitable fat-replacers can be selected to mimic the effects of the fat component in the batter-like composition, for example, by binding water present in the batter-like composition and/or providing fat-like sensory properties in the baked products. The fat-replacer can improve softness, texture, and/or mouthfeel of baked products prepared from batter-like compositions containing the replacer. In some embodiments, the fat-replacer can improve the strength and structure of a batter-like composition, reduce sugar and/or water migration to the surface of the batter-like composition (and intermediate products prepared therefrom), and improve yield.

One type of fat-replacer suitable in accordance with the invention is fiber. Any suitable fiber obtained from a plant source can be utilized in accordance with the invention. An illustrative fiber is citrus fiber. A commercially available citrus fiber that can be useful is Citri-Fi™ (Fiberstar, Inc., Willmar, Minn.).

In some aspects, the inventive batter-like compositions include chemical leavening systems. Chemically-leavenable (“chemically-leavened”) batter-like compositions are batter-like compositions formulated to leaven to a substantial extent by the action of chemical ingredients that react to produce a leavening gas. Typically, the ingredients of a chemical leavening system include a basic chemical leavening agent and an acidic chemical leavening agent that react together to produce carbon dioxide, which, when retained by the batter-like matrix, causes the batter-like composition to expand. Chemically-leavenable batters or dough compositions can be contrasted to batter or dough formulations that are substantially leavened due to the action of yeast as a leavening agent, that is, by metabolic action of yeast on a substrate to produce carbon dioxide. While batter-like compositions of the invention can include yeast, for example, as a flavoring agent, certain batter-like compositions of the invention do not include yeast as a leavening agent.

Basic chemical leavening agents are generally known in the baking arts, and any chemical leavening base that is capable of undergoing a reaction with a chemical leavening acid is suitable for use in the batter-like compositions of the invention. A basic agent may be encapsulated or non-encapsulated. Both encapsulated and non-encapsulated basic chemical leavening agents are generally known and commercially available, and can be prepared by methods known in the baking and encapsulation arts.

As a result, only the exemplary chemical leavening bases, namely sodium bicarbonate (baking soda), ammonium carbonate, ammonium bicarbonate, and potassium bicarbonate, are recited herein. In some aspects, baking soda can serve as the primary source of carbon dioxide gas in many chemical leavening systems.

Acidic chemical leavening agents are generally known in the baking arts, with examples including sodium aluminum phosphate (SALP), sodium acid pyrophosphate (SAPP), monosodium phosphate, monocalcium phosphate monohydrate (MCP), anhydrous monocalcium phosphate (AMCP), dicalcium phosphate dihydrate (DCPD), dicalcium phosphate (DCP), sodium aluminum sulfate (SAS), glucono-delta-lactone (GDL), potassium hydrogen tartrate (cream of tartar) as well as a variety of others, and combinations of any of these. Commercially available acidic chemical leavening agents include those sold under the trade names: Levn-Lite® (SALP), Pan-O-Lite® (SALP+MCP), STABIL-9® (SALP+AMCP), PY-RAN® (AMCP), and HT® MCP (MCP). Acidic chemical leavening agents come in a variety of solubilities at different temperature ranges, and may be either encapsulated or non-encapsulated. An illustrative leavening system includes sodium aluminum phosphate and baking soda.

In some embodiments, dimagnesium phosphate trihydrate can be used as the major acidic chemical leavening agent in batter-like compositions. In accordance with these aspects of the invention, an acidic leavening agent consisting essentially of dimagnesium phosphate trihydrate can be utilized in combination with a basic leavening agent in a batter-like composition to provide desirable leavening.

Suitable dimagnesium phosphate trihydrate can be obtained from commercial sources, for example, from Chemische Fabrik Budenheim, K G (Budenheim, Germany, product dimagnesium phosphate, 3-hydrate, fine powder, FCC M52-81, CAS No. 7757-86-0). In some embodiments, the neutralizing value (NV) and/or particle size of the dimagnesium phosphate trihydrate can be relevant in providing acceptable leavening activity. For example, dimagnesium phosphate trihydrate having a relatively fine particle size can be particularly useful. In some aspects, the dimagnesium phosphate trihydrate has a mean particle size of 17 μm or 15 μm or less, or 10 μm or less.

In accordance with some aspects of the invention, a batter-like composition is provided, the batter-like composition comprising a structure-providing amount of flour or flour replacement ingredient; sweetener in an amount effective to provide a water activity of about 0.94 or less; fat source; and a chemical leavening system, the chemical leavening system comprising a basic leavening agent and dimagnesium phosphate trihydrate as acidic leavening agent, the dimagnesium phosphate trihydrate comprising at least about 75% by weight of the acidic leavening agent. In other aspects, the dimagnesium phosphate trihydrate can comprise about 80% or more, or about 85% or more, or about 90% or more, or about 95% or more, or about 100% of the acidic leavening acid. In some aspects, the inventive batter-like compositions include less than about 30% by weight, or less than about 20% or less than about 10% or less than about 5% amorphous dimagnesium phosphate based on weight of the acidic leavening agent.

In accordance with the invention, dimagnesium phosphate trihydrate can be employed as the acid factor in leavening systems in typical application with a carbonate factor. Carbonate factors include any suitable basic materials such as sodium bicarbonate as well as other basic materials such as potassium bicarbonate, amorphous calcium carbonate, ammonium bicarbonate and the like, including those described herein.

Advantageously, dimagnesium phosphate trihydrate can be utilized with unencapsulated basic chemical leavening agents. Thus, in some aspects, the invention provides batter-like compositions that include a leavening system comprising dimagnesium phosphate trihydrate as acidic leavening agent and an unencapsulated leavening base. In accordance with these aspects of the invention, the ability to use a leavening system that does not require encapsulated leavening agents (acidic or basic) can provide cost savings in production of the batter compositions.

In other aspects of the invention, the major leavening activity of the acidic component can be provided by: (1) dimagnesium phosphate trihydrate in combination with dicalcium phosphate, or (2) dicalcium phosphate alone, or (3) dicalcium phosphate in combination with SALP. In these aspects, the invention provides batter compositions comprising a structure-providing amount of flour or flour replacement ingredient; sweetener in an amount effective to provide a water activity of 0.94 or less; fat source; and a chemical leavening system, the chemical leavening system comprising a basic leavening agent and a major acidic leavening agent selected from: (a) dimagnesium phosphate trihydrate in combination with dicalcium phosphate, or (b) dicalcium phosphate alone, or (c) dicalcium phosphate in combination with SALP, wherein the major acidic leavening agent comprises at least 75% by weight of the acidic leavening agent. In other aspects, the major acidic leavening agent can comprise 80% or more, or 85% or more, or 90% or more, or 95% or more, or 100% of the acidic leavening acid.

In accordance with the invention, when acidic leavening agents are included in addition to the major acidic leavening agent, these agents are typically included in minor amounts. The relative amounts of leavening acids, and relative amounts of acidic leavening agents to basic leavening agents, can be calculated based upon the neutralizing value (NV). The NV is calculated by dividing the carbon dioxide carrier by the amount of leavening acid needed for neutralization. The NV calculation can be represented by the following formula:

$$NV = \frac{sodium bicarbonate}{leavening acid} \times 100$$

Below are illustrative amounts of carbon dioxide carriers, leavening acids, and neutralizing values for various cooked product types.

| | Sodium | |
|---|---|---|
| | Bicarbonate | |
| | % Flour or | Leavening |
| Product type | Starch Base | Acids |
| Sponge Cake | 1.0-1.5 | SAPP, SALP, MCPM |
| Aerated Batter | 0.6-0.8 | SAPP, MCPM, Baking Powder |
| Waffle | 0.3-0.8 | SAPP |
| Stolen | 1.0-2.0 | SAPP |
| Muffin | 1.6-2.5 | SAPP, Baking powder |
| Pancakes | 1.6-2.0 | SALP, SAPP |
| Layer cake | 0.7-1.0 | SAPP, SALP |
| Angel cake | 1.6-2.0 | SAPP, SALP, Fumaric, MCPM |
| Ready to Cook | 0.1-2.0 | DMP, DCPD |
| Batters in accordance | | |
| with the invention | | |

The chemical leavening agents can be present in an amount that provides one or more useful properties as described herein, including stability at refrigeration and/or frozen temperatures, desired refrigerated and/or frozen uncooked specific volume, and desired baked or cooked leavening properties following refrigerated and/or ambient storage. For example, the leavening system can make up about 5% by weight of the batter composition, or in the range of about 0.4% to about 1% by weight of the batter composition, and the relative amount of leavening acid to leavening base can be selected taking into consideration the NV as discussed herein. Illustrative NV for sodium bicarbonate are shown below:

| NV for Sodium | |
|---|---|
| Bicarbonate | Leavening Acid |
| SAPP | 73 |
| MCPM | 80 |
| SALP | 100 |
| DCPD | 33 |
| DMP3H* | 40 |

The chemical leavening agents can be present in an amount that provides one or more useful properties as described herein, including stability at refrigeration and/or frozen temperatures, desired refrigerated and/or frozen raw specific volume, and desired baked leavening properties following refrigerated and/or frozen storage. For example, the leavening system can make up about 5% by weight of the batter-like composition, or in the range of about 0.4% to about 1% by weight of the batter-like composition, and the ratio of leavening acid to leavening base can be in the range of about 1:1 to about 1.5:1.

In some aspects, the amount of chemical leavening system can be included to provide a density in the range of about 0.4 g/cc to about 1.3 g/cc, or in the range of about 0.65 g/cc to about 1.2 g/cc, or about 0.8 g/cc to about 1.2 g/cc during refrigerated and/or frozen storage, as well as a desired baked specific volume upon baking, such as a baked specific volume in the range of about 2.5 cc/g to about 5.0 cc/g.

In some embodiments, one or more of the chemical leavening agents of the leavening system can be encapsulated. (As used throughout this description and claims, unless otherwise noted, amounts of chemical leavening agents and encapsulated chemical leavening agents are given in terms of the amount of active leavening agent not including the weight of any encapsulant or barrier material). Illustrative encapsulated chemical leavening agents and encapsulation techniques are described, for example, in U.S. Publication No. 2003/0049358 A1 (“Chemical Leavened Doughs and Related Methods,” Domingues, published Mar. 13, 2003).

Encapsulated basic chemical leavening agents are generally known, and can be prepared by methods known in the baking and encapsulation arts. An example of a method for producing enrobed particles is the use of a fluidized bed.

Encapsulated basic chemical leavening agents are typically particles that include solid basic chemical leavening agent particulates covered in part, for example, substantially completely, by a barrier material or encapsulant. Encapsulated particles are known in the baking arts, and include encapsulated particles sometimes referred to as “enrobed” particles, as well as those sometimes referred to as “agglomerated” particles. The barrier material or encapsulant forms a coating or shell around a single or multiple particulates of solid basic chemical leavening agent, separating the chemical leavening agent from a bulk dough composition. “Enrobed” particles generally include a single particulate of chemical leavening agent covered or coated by barrier material, and “agglomerate” particles generally include 2, 3, or more particulates of chemical leavening agent contained in a mass of barrier material.

Encapsulating the basic chemical leavening agent provides separation between the basic chemical leavening agent and the bulk of the batter-like composition to inhibit, prevent, or slow the progress of reaction of the basic and acidic leavening agents. On the other hand, due to cracks, incomplete coverage, or damage to encapsulated particles, some amount of basic agent can be exposed, allowing it to dissolve into a batter-like composition, contact leavening acid, and react to produce carbon dioxide. Due to such imperfect encapsulation, acidic leavening agent can react with an amount of exposed basic leavening agent during refrigerated storage, to produce carbon dioxide gas that can expand the batter-like composition.

An encapsulated basic chemical leavening agent may be selected based on its degree of encapsulation or “activity.” “Activity” refers to the percentage by weight of basic chemical leavening agent that is contained in encapsulated particles based on the total weight of the particles. A useful degree of encapsulation or activity can be an activity that allows a desired amount of basic agent to be released from encapsulation prior to baking, to result in desired stored and cooked dough properties. According to embodiments of the invention, an encapsulated basic chemical leavening agent can have any useful activity, with activities in the range from 50 to 90 percent, for example, 70 to 80 percent, being exemplary.

The inventive batter-like compositions can include an emulsifier component. The emulsifier component can include one or more emulsifiers. Emulsifiers can be nonionic, anionic, and/or cationic surfactants that can influence the texture and homogeneity of the batter-like composition, increase stability of the batter-like composition (including freeze/thaw stability), and/or improve eating quality of the finished product. In some aspects, the shortening component provides a convenient carrier for addition of emulsifiers to the batter-like composition. Such emulsifiers can aid the realization of baked goods with improved grain structure and texture. The emulsifier can also be useful to maintain the emulsion integrity of the batter-like composition over extended storage (such as extended room temperature storage).

All or a portion of the emulsifier component can be admixed with the shortening component. Some emulsifier(s), such as monoglycerides, have relatively higher melting points than the fat component. Consequently, as more emulsifier is added to the fat component to form an emulsified fat component, its melting point and hardness increases. As the increased emulsifier levels “harden” the fat component, blending with other ingredients of the batter-like composition can become more difficult. Thus, in some embodiments, a first portion of the emulsifier can be preblended with the fat source, a second portion can be added in its dry powder form, while a third portion can be admixed in liquid form.

The emulsifier typically comprises up to about 25% of the shortening component, or about 5% to about 15%, or about 10% to about 15%, or about 15% to about 25% of the shortening component. When preblended with the fat component to form an emulsion, the emulsion can contain at least about 2% to about 10% by weight of the fat source of the emulsion, or about 3% to about 5% of the emulsion. In further aspects, the amount of emulsifier in the batter-like composition can be in the range of about 0.3% to about 10%. In one illustrative embodiment, wherein the batter-like compositions are utilized to provide muffin baked products, the batter-like composition can include the emulsion in an amount of about 25%, wherein about 44% of the emulsion comprises a fat source (based upon the weight of the emulsion), and about 14% of the emulsion comprises emulsifier (based upon the weight of the emulsion).

Emulsifiers can be prehydrated in an aqueous dispersion and added to the batter-like composition. They can also be part of an emulsion or dispersion with or without a fat component. Generally useful as the emulsifiers are partially esterified polyhydric compounds having surface-active properties. This class of emulsifiers includes among others, mono- and diglycerides of fatty acids, such as monopalmitin, monostearin, monoolein, and dipalmitin; partial fatty esters of glycols, such as propylene glycol monostearate and monobehenate; glyceryl-lacto esters of fatty acids; ethoxylated mono- and diglycerides; higher fatty acid esters of sugars, such as the partial palmitic and oleic acid esters of sucrose; and phosphoric and sulfuric acid esters, such as dodecyl-glyceryl ether sulfate and monostearin phosphate. Other examples include the partial esters of hydroxycarboxylic acids, such as lactic, citric, and tartaric acids with polyhydric compounds, for example, glycerol lacto-palmitate, and the polyoxyethylene ethers of fatty esters of polyhydric alcohols, such as a polyoxyethylene ether of sorbitan monostearate or distearate. Fatty acids alone or esterified with a hydroxy carboxylic acid, for example stearoyl-2-lactylate, are also useful.

In some aspects, all of the emulsifier is added to the formulation as part of the emulsion (in other words, during addition of ingredients to form the batter-like composition, 100% of the emulsifier is included in the emulsion). In other aspects, only a portion of the emulsifier is added to the formulation as part of the emulsion. In these latter aspects, a portion of the emulsifier is added during preparation of the batter-like composition, as an ingredient separate from the emulsion itself.

The total amount of emulsifier(s) in the batter-like compositions can be adjusted such that suitable organoleptic properties are obtained. That is, the total level of emulsifiers in the batter-like compositions can be adjusted such that the final baked goods prepared from the inventive batter-like compositions have a rich mouthfeel, a smooth texture and a baked specific volume as described herein. Some illustrative baked specific volumes include about 0.2 g/cc to about 0.4 g/cc (for pancakes); about 0.3 g/cc to about 0.6 g/cc (for cakes); and other appropriate baked specific volumes based upon the final baked good to be prepared.

In some embodiments, the emulsion is provided by a prepared water-in-oil (w/o) emulsions, such as butter or margarine. Typically, these emulsions are commercially available and include some emulsifier. In some aspects, the w/o emulsion is a high-moisture emulsion, to achieve the beneficial features of the emulsion discussed herein. In some aspects, the high-moisture emulsion includes a water:fat ratio in the range of about 90:10 to about 60:40. In some aspects, most, but not all, water present in the batter-like compositions described herein are bound in the emulsion (as described above). One commercially available w/o emulsion found useful in the present invention is a high-moisture margarine, such as commercially available from Unilever under the product name Promise Lite™. In some aspects, the w/o emulsion is added in solid form during formulation of the batter-like composition.

In accordance with the invention, one or more optional components can be included in the batter-like compositions. Such optional components will now be described.

In some aspects, the inventive batter-like compositions can include anti-sticking agents. Anti-sticking agents can be added to the formulation to reduce surface moistness and/or surface tackiness that can occur with the inventive compositions and intermediate products. Use of anti-sticking agents can, in some aspects, improve handling of the inventive compositions and/or intermediate products by providing compositions/products that can be easily picked up and handled by a consumer and/or formulator. In accordance with the invention, anti-sticking agents can reduce or prevent sticking and/or clumping when one surface of a composition or intermediate product of the invention contacts another surface of a composition or intermediate product.

One of skill in the art, upon review of the present disclosure, will readily appreciate that one or more anti-sticking agents can be utilized in connection with the inventive compositions and/or intermediate products. One or a combination of different types of anti-sticking agents can be utilized with no other materials, to reduce or prevent sticking. Alternatively, one or a combination of different types of anti-sticking agents can be combined with another material such as water or a liquid fat or oil, and then combined with the inventive compositions and/or intermediate products. For example, utilization of an oil or fat with an anti-sticking agent can reduce or prevent the tendency of the anti-sticking agent to form a cloud of dust during processing (for example, when the anti-sticking agent is a powder that is applied to a surface of the inventive compositions and/or intermediate products).

Anti-sticking agents can be combined or added to batter-like compositions and/or intermediate products of the invention by any useful method, such as during, before, or after any one or more of the steps for preparing compositions and products described herein. In some aspects, anti-sticking agents can be applied on a surface of a batter-like composition that has already been prepared from its basic ingredients and/or that has been formed into intermediate products as described herein. Such application can be performed before or after placing the compositions and/or intermediate products into storage conditions. For example, edible powder can be applied as a surface treatment to the inventive compositions and/or intermediate products. In other aspects, anti-sticking agents can be added as a component of the batter-like composition, and mixed with other components.

Useful anti-sticking agents include various flours, starches, gums and hydrocolloids.

Useful flours include high gluten flour, soft wheat flour, hard wheat flour, rice flour, semolina flour, and others. Other useful anti-sticking agents include powdered vegetable shortening, sodium silicoaluminate, and carboxy-methylcellulose.

Gums for food use include edible polymeric materials that are soluble in water and can cause a viscous or gelled consistency in foods. Some functional properties of gums include water binding, encapsulating, and structure forming. Useful gums include xanthan gum, guar gum, locust bean gum, gum arabic, and the like. Useful gums derived from seaweeds include agar, alginates, carrageenans, and furcellaran. Useful synthetic gums include microcrystalline cellulose, carboxymethylcellulose, methylethylcellulose, and hydroxypropylcellulose, and the like.

Hydrocolloids for food use include hydrophilic polymers that can be of vegetable, animal, microbial, or synthetic origin. Hydrocolloids generally contain many hydroxyl groups and can be polyelectrolytes. Some functional properties of hydrocolloids can include water binding, thickening and gelling (thus impacting viscosity), emulsion stabilization, prevention of ice recrystallization, and organoleptic properties. Many materials can be described as gums and hydrocolloids. Thus, many of the materials mentioned above as suitable gums could also be described as hydrocolloids (such as agar, alginate, carrageenans, carboxymethylcellulose, cellulose, guar gum, gum arabic, locust bean gum, and xanthan gum). Other illustrative hydrocolloids include arabinoxylan, curdlan, gelatin, gellan, β-glucan, pectin, starch.

One illustrative class of naturally occurring hydrocolloid that can be useful in the inventive compositions is derived from red seaweed and other gelling hydrocolloids. These hydrocolloids are referred to as “agaroids” and constitute readily soluble agars. Suitable agaroids are commercially available, for example, from TIC Gums (Belcamp, Md.), including Agaroid RS products such as Agaroid RS-30, Agaroid RS-507, Agaroid RS-520, Agaroid RS-500, and Agaroid RS-575.

Other useful anti-sticking agents include starch. The starch used can be any of the common food starches, for example, potato starch, corn starch, wheat starch, rice starch, barley starch, oat starch, tapioca starch, arrowroot, sago starch, and the like. Modified starches and pregelatinized starches can also be used. In addition to providing anti-sticking features, starch inclusion can influence a variety of product attributes including viscosity, finished baked goods' volume and texture.

When present, the anti-sticking agent can comprise up to about 0.45% by weight of the total batter-like composition, or in the range of about 0.05% to about 0.45%, or about 0.1% to about 0.45% by weight of the total batter-like composition.

When the anti-sticking agent is applied as a surface treatment, the agent(s) can be deposited at a surface of a batter-like composition and/or intermediate product by any useful method. In some aspects, the anti-sticking agent can be placed on one or more surfaces of batter-like compositions and/or intermediate products, or portions thereof, for example, by coating the anti-sticking agent, by itself or with other materials, using any technique such as well known techniques of spraying, brushing, dusting, or tumbling. Such steps can be accomplished before and/or after placing the compositions/intermediate products into storage conditions.

If present, the total added starch ingredient(s) outside the flour replacement ingredient (for example, the added starch for purposes of anti-sticking properties and/or additional product attributes described above) can comprise about 0.05% to about 10% of the batter-like composition, or about 0.1% to about 10%, or about 1% to about 8% of the batter-like composition.

Optionally, the inventive batter-like compositions can include an egg component. The egg component can be present as liquid eggs, typically pasteurized liquid eggs or frozen whole eggs. The pasteurized liquid eggs or frozen whole eggs can provide desirable structuring, emulsification, and/or nutritional benefits to the inventive batter-like compositions. Pasteurized liquid eggs can also provide at least a portion of the total moisture of the batter-like compositions. Useful amounts of liquid eggs include up to about 30% by weight (based upon the total weight of the batter-like composition), or in the range of about 1% to about 20%, or about 5% to about 18%. It will be appreciated that liquid eggs comprise about 75% moisture. In some embodiments, the liquid eggs can be replaced in whole or in part with dried eggs solids, or egg fractions in solid form (for example, egg yolk solids and egg white solids).

An antimycotic agent can optionally be incorporated in the batter-like composition to enhance microbial stability. Useful agents include sorbic acid and its derivatives such as sodium or potassium sorbate, propionic acid and its derivatives, vinegar, sodium diacetate, monocalcium phosphate, lactic acid, citric acid, and the like. These agents can be present in an amount effective to inhibit the growth of undesirable microbes such as yeasts and/or molds. When present, the antimycotic agent(s) can be included in the amount up to about 0.2% by weight, or in the range of about 0.1% to about 0.2% by weight. The amount included will typically be selected to provide an antimycotic effect, while avoiding or minimizing any noticeable off-taste to the batter-like composition.

Optionally, the inventive batter-like compositions can include a variety of additional minor ingredients or “conventional additives” suitable for rendering finished baked goods prepared therefrom more organoleptically desirable. Such optional dry mix components include anti-oxidants, salt, coloring agents, flavoring agents, egg solids, milk solids, preservatives, gluten, spices, flavor chips, and particulates (such as nuts, fruit pieces, and other edible inclusions). Flavor chips can include chocolate, mint chocolate, butterscotch, peanut butter chips, and mixtures thereof. The flavor chips can be coated with topical film to minimize moisture migration such as with a hard fat or with edible shellac. Inclusions can include fruit (such as berries), nuts, and the like. Optionally, the inclusions (such as fruit pieces) can be coated with starch or cellulose gum, for example, to reduce or minimize bleeding of the fruit color into the batter during mixing and/or depositing. If present, such optional components collectively comprise about 1% to about 15% of the batter-like composition.

One illustrative minor ingredient is calcium acetate. Calcium acetate can be employed as a thickening agent, texture modifier, a preservative, and/or as a buffer for pH.

In some aspects, for example, when the batter-like compositions are formulated for refrigerated storage conditions, the compositions can include preservatives, such as anti-microbial agents commonly used in dough and/or batter formulation.

In some embodiments, an oxidoreductase enzyme can be included in a packaged batter-like composition to prevent or reduce enzymatic discoloration of a batter-like composition. The enzyme can be included in the batter-like composition itself, in only a portion of the batter-like composition such as at a surface, or elsewhere in a packaged batter-like composition at a location effective to inhibit or prevent discoloration. The oxidoreductase enzyme can be any enzyme that effectively causes a non-discoloring reaction between oxygen and a substrate to consume oxygen within the batter-like composition or packaged batter-like product and prevent the oxygen from otherwise reacting to cause discoloration of the batter-like composition. An exemplary oxidoreductase enzyme useful in accordance with the invention is glucose oxidase, such as commercially available under the product name GLUZYME (manufactured by Novozymes).

In some aspects, the inventive batter-like compositions have a water absorption that is comparable to conventional batters. The water absorption can be calculated based upon the water added to dry materials in the product (H₂O/dry matter=Absorption).

In some aspects, the batter-like compositions can have a total moisture content comparable to that of conventional batters. The total moisture content includes water provided with or associated with the various essential and optional ingredients. For example, total moisture includes the moisture associated with flour, starch, cocoa and especially liquid eggs. The total moisture can be easily determined by vacuum oven drying of the batter-like compositions herein. Unlike conventional batters, however, the inventive compositions can tie up water within the composition in a manner that provides a non-flowable intermediate product (such as a puck) that is capable of retaining its integrity until the product is exposed to baking temperatures, at which time water is freed and the composition behaves more like a conventional batter. The total moisture content of the inventive batter-like compositions can be in the range of about 20% to about 40% or about 30% to about 40%, or about 34% to about 40%.

The particular selection of ingredients and concentrations are selected to provide batter-like compositions having a water activity comparable to conventional batters. As described herein, water activity can impact the shelf life of batter-like compositions. By measuring water activity, it is possible to predict which microorganisms will and will not be potential sources of spoilage. Water activity determines the lower limit of available water for microbial growth. In addition to influencing microbial spoilage, water activity can play a significant role in determining the activity of enzymes and vitamins in foods and can have an impact on the food's color, taste, and/or aroma. In some aspects, selection of such water activity value can provide a balance between microbial shelf stability and handling characteristics of the inventive compositions.

Generally speaking, the pH level of batter-like compositions can impact stability and leavening capacity of the compositions as well. The inventive batter-like compositions can have a pH that is comparable to conventional batters.

The inventive batter-like compositions provide a novel product category that is distinct from conventional batters and doughs, yet possesses some desirable characteristics of each. For example, the inventive compositions can provide water absorption, water activity and pH that is comparable to conventional batters, yet provide structural features (for example, non-flowable characteristics even at temperatures above storage temperatures) that have heretofore been unachievable with batters. The inventive batter-like compositions are surprisingly capable of maintaining a discrete form (such as a puck), while retaining product attributes typically associated with batter compositions. As mentioned elsewhere here, traditional batters are considered to be less viscous than doughs, and are typically flowable. At the same time, however, batters typically possess a higher level of free water relative to doughs. The inventive batter-like compositions include the higher level of free water, yet are capable of retaining a discrete form that is easily handled by a consumer and is capable of storage for extended periods at a variety of temperatures.

The inventive batter-like compositions are formulated to retain a discrete shape, such as a puck, during storage and handling prior to baking. Upon exposure to heating temperatures during the baking process, however, the batter-like compositions become flowable and behave more like a traditional batter. In some aspects, the batter-like compositions provide significant flexibility in the type of baked goods that can be prepared therefrom. For example, batter-like products (such as in the form of pucks) can be utilized to prepare muffins, as described herein. In other illustrative embodiments, multiple batter-like products (such as pucks) can be placed adjacent each other (for example, touching, in a side-by-side manner and/or stacked on top of each other) at the time of baking, to provide a cake, brownie, or other similar baked good. In these aspects, upon application of heat during the baking process, the multiple batter-like products become more flowable at baking temperatures and can combine to form a final baked good that is a combination of the individual batter-like pieces. Put another way, the batter-like units are no longer discrete upon baking in these aspects. The final baked product in these aspects is a unitary baked good that can be subsequently portioned (for example, but cutting), as with traditionally-prepared cakes and/or brownies.

The size and dimensions of the individual batter-like units can be selected based upon the final baked product. It will be readily appreciated that the particular size and dimensions are not critical. In some aspects, the batter-like compositions can form discrete product units (such as pucks) in a size of approximately 2 ounces. This particular size portion has been found useful for preparing muffins. Additionally, the 2-ounce size can provide packaging and manufacturing efficiencies. Moreover, the 2-ounce pucks are easily combined to provide larger muffins, cakes, coffee cakes, brownies, and the like.

In some aspects, the batter-like compositions of the invention provide desirable viscoelastic properties, such as composition consistency. In some aspects, the inventive batter-like compositions have a consistency above about 100 FU, or above about 150 FU, or above about 200 FU at refrigerated temperatures (approximately 32° F. to 42° F. (0° C. to 5.6° C.)). This property can be determined by making a Farinograph measurement (see The Farinograph Handbook, Locken et al. (ed.), American Association of Cereal Chemists, Inc. (1972) for a general discussion of Farinographs).

In some aspects, the inventive batter-like compositions possess sufficient spreadability to provide batter-like products that are capable of maintaining product integrity during handling, storage, and prior to baking, yet provide suitable flowable batter-like characteristics upon application of baking conditions (such as heating). The spreadability of the batter-like compositions can be expressed as a function of the amount of composition spread observed upon compression of the product, and is expressed as kilogram/second (kg/s). Hardness of the composition is typically expressed in kg of force. As described herein, the spreadability and hardness of the compositions is determined at freezing temperatures, for example, less than about 30° F. (−1.1° C.), or in the range of about −10° F. (−23.3° C.) to about 30° F. (−1.1° C.). One method of measuring product spread (spreadability) utilizes a texture analyzer that compresses the sample and measures area of spread (for example, TA/XT Plus texture analyzer from Texture Technologies Corp.). In some embodiments, the batter-like compositions have a spreadability in the range of above about 5 kg/second (kg/s), or in the range of about 5 kg/s to about 90 kg/s, or about 5 kg/s to about 85 kg/s at freezing temperatures.

In further aspects, the inventive batter-like compositions can provide desirable hardness that is sufficient to provide a discrete product unit that can be handled during processing, storage, and prior to baking. Hardness can be measured utilizing a texture analyzer, such as described above. Hardness is typically expressed in units of force required to compress a product. In some embodiments, the batter-like compositions have a hardness above about 2 kg, or in the range of about 2 kg to about 70 kg, or about 2 kg to about 60 kg at freezing temperatures.

In further aspects, the batter-like compositions can have a density in the range of about 0.78 g/cc to about 1.2 g/cc. The density can depend upon such factors as the final baked good to be prepared from the batter-like compositions, and the like. Illustrative densities for batter-like compositions include the following: 0.78 g/cc to 0.8 g/cc (cakes); 1 g/cc to 1.1 g/cc (muffins); 1 g/cc to 1.04 g/cc (pancakes). Other attributes of the inventive batter-like compositions can be comparable to conventional batters, such as pH and water activity. Illustrative pH ranges for batter-like compositions of the invention are relatively neutral, in the range of about 6.6 to about 7.4. Illustrative water activity for the inventive batter-like compositions can be about 0.97 or less, or about 0.94 or less, or in the range of about 0.95 to about 0.8. The batter-like compositions thus can exhibit some properties that are comparable to conventional batters, yet additional properties heretofore unavailable for such conventional batters.

Batter-like compositions of the invention can generally be prepared by preparing an emulsion including emulsifier, fat source, and water, (and optionally gums or hydrocolloids), then adding the emulsion to a batter-like base to form a batter-like composition, and forming the batter-like composition into discrete units (pucks). The discrete pieces can then be frozen or refrigerated for storage until baking.

In some aspects of the invention, the majority of the water of the batter-like compositions is included in the emulsion. Without intending to be bound by a particular theory, it is believed that by entrapping a majority of the water in the emulsion during formulation of the batter-like compositions, the batter-like composition can provide a desired level of structural integrity (ability to maintain the discrete form of the intermediate farinaceous product, such as puck). As discussed elsewhere herein, it is typically desirable to include more free water within batter compositions relative to dough. The inventive batter-like compositions thus include high amounts of free water while also providing a discrete product unit that is easily processed during formation of the raw product, and easily handled by a consumer during preparation of a baked good.

An emulsion can be prepared by obtaining a fat source, heating the fat source in the presence of at least a portion of the total emulsifier to be included in the batter-like composition, and mixing the fat source with selected emulsifiers and water. The emulsifiers are not necessarily combined with the fat source prior to addition to the batter-like base, although such preblending is preferred for at least a portion of the emulsifiers as described herein. In some aspects, the emulsion includes all of the emulsifier to be included in the overall batter-like composition. In some aspects, the emulsion is cooled prior to adding the emulsion to the batter-like base.

Generally speaking, the fat source is provided in a solid form and is melted in the presence of emulsifiers during formation of an emulsion. The fat source and emulsifier(s) can be heated using any suitable methods and mixed until an emulsion is obtained having a desired particle size. The temperature for formation of the emulsion can vary, but is typically in the range of about 100° F. to about 250° F. (37.8° C. to about 121.1° C.). The temperature is typically selected to be above the melting point of the fat source.

Generally, the emulsion is blended to provide a substantially homogeneous mixture. Any stirring method that provides sufficient sheer to form an emulsion can be used. In some aspects, the fat source and emulsifier(s) are stirred under high sheer conditions.

The order of addition of the fat source, emulsifiers, and water is not critical. In some embodiments, the emulsifiers are added in powdered form, for ease of addition and mixing.

In some aspects, formation of the emulsion can involve preparation of a solution that includes desirable gums and/or hydrocolloids. In one embodiment, a gum/hydrocolloid solution can be prepared having the following components:

| Ingredient | Amount (weight percent) |
|---|---|
| Water | 80-90 |
| Gums and hydrocolloids | 0-2 |
| Oil | 8-9 |
| SSL | 0.5-1.5 |
| Starch | 0.5-1.5 |
| K-Sorbate | 0-1 |

In one illustrative embodiment, the emulsion is prepared in multiple stages as follows. In a first stage, a portion of the total emulsifier is combined with the fat source, heated and mixed until the ingredients are suitably melted and mixed. In a second stage, water and gums and/or hydrocolloids are combined, heated and mixed for a suitable time to combine the hydrocolloids/gums and water, and to activate the gum(s) and/or hydrocolloid(s). The first and second stages are then combined and mixed under high sheer conditions for a time sufficient to achieve an emulsion. Additional emulsifier can be added at this point, if desired. Combination and blending of the components of the emulsion can be performed in any suitable blending equipment for mixing batters or doughs, such as mixers available from Breddo Likwifier (Kansas City, Mo.), which include a heating component (for example, a steam jacketed kettle). Components are heated within the kettle to a range of about 160° F. to about 170° F. (71.1° C. to about 76.7° C.), which is sufficient to melt the components, and in particular to melt the solid fat component.

Optionally, the process can further include a stage of homogenizing the blended components of the emulsion to form an homogenized emulsion system. During homogenization, the fat component is dispersed in the system, and seeding and crystallization of the fat can occur. The homogenizing stage can utilize a two-stage piston (for example, 100 psi, 750 psi) homogenizer. For instance, the homogenization stage can reduce the fat particle size to a few microns in diameter.

The emulsion can then be rapidly cooled to a temperature in the range of about 40° F. to about 200° F. (4.4° C. to about 93.3° C.). The principle of this step is to convert the molten shortening in the emulsion system into plastic shortening in situ after it has been dispersed in the emulsion system. Rapid cooling is believed to promote desirable growth in the shortening of beta prime tending fat crystals that can better hold the gas within the small air cells. Such gas entrainment can minimize coalescence upon storage. For example, immediately after formation of the emulsion (or, immediately after homogenization, when this step is included), the composition can be passed through a swept surface heat exchanger and cooled to less than about 90° F. (32.2° C.), or less than about 85° F. (29.4° C.). A suitable device for this stage is commonly referred to as a “Votator” and is described in U.S. Pat. No. Re. 21,406 to C. W. Vogt (Mar. 19, 1940).

Typically, the emulsion will have a formula of the relative amounts shown below:

| Ingredient | Amount (weight percentage) |
|---|---|
| Water | 42 |
| Shortening | 33 |
| Emulsifier | 12 |
| Liquid oil | 11 |
| Gums/hydrocolloid | 0.2 |
| SSL | 1 |
| Total | 100 |

The emulsion is combined with a batter-like base to form a batter-like composition of the invention. Typical batter-like compositions comprise the emulsion in an amount up to about 40% by weight, or in the range of about 10% to about 35%, or in the range of about 20% to about 30% by weight.

For combination of the emulsion and batter-like base, the emulsion can be transferred to any suitable mixing equipment, particularly high speed dough or batter mixing equipment, such as a Duromol Mixer (Spooner Vicars, Merseyside, England). The batter-like base includes conventional ingredients for batters, as described herein. Typical components and ranges of a batter-like base are shown below:

| Ingredient | Useful ranges (weight percent) |
|---|---|
| Flour | 20-50 |
| Sweetener | 5-55 |
| Water | 5-40 |
| Fat component | 0-25 |
| Leavening system | 0-5 |
| Minor ingredients | 0-8 |

Typically, a dry mix including the components of the batter-like base (without added water) is prepared. Water is then added to the dry mix in an amount to provide a sufficiently hydrated batter-like base. Optionally, other liquid components can be added instead of, or in addition to, the water. Illustrative liquid components include liquid egg components and/or whole egg. The water and dry mix are typically mixed for a time and speed suitable to provide a hydrated batter-like base.

The prepared emulsion can then be added to the prepared batter-like base, and the combination mixed for a time and speed sufficient to provide lump-free incorporation of the ingredients in the mixture. Optional ingredients such as inclusions, flavoring agents, and the like can be added at a final stage of the preparation.

One illustrative formulation for batter-like compositions is as follows:

| Ingredient | Useful ranges (weight percent) |
|---|---|
| Flour | 20-50 |
| Sweetener | 5-55 |
| Water | 5-40 |
| Fat component | 0-25 |
| Leavening system | 0-5 |
| Gums | 0-2 |
| Starch | 0-10 |
| Minor ingredients | 0-6 |

In some embodiments, steps of forming an emulsion can be substituted by providing a solid water-in-oil emulsion, such as commercially available margarines. In some aspects, the w/o emulsion is a high-moisture emulsion, such as a high-moisture margarine. When a commercially available w/o emulsion is utilized instead of preparing the emulsion described above, the following ingredients can be combined to provide a batter-like composition:

| Ingredient | Amount (weight percentage) |
|---|---|
| Water | 4.5 |
| Shortening | 4.5 |
| Batter-like base | 48 |
| Emulsifiers | 3 |
| Margarine | 16 |
| Egg component | 14 |
| Minors | 0-10 |
| Total | 100 |

In some embodiments, fat-replacer can be included in the formulation, as discussed herein.

Once the batter-like composition has been prepared, it can be further processed according to known methods of forming dough compositions into a desired size and shape (followed by other processing steps such as packaging, freezing, and baking). A variety of techniques can be used for processing, as are known. For example, processing of the batter-like composition can include one or more of sheeting, extruding, dividing and rounding, and the like; cutting to a desired size and shape; folding; filling; and baking. According to the invention, any processing steps can be useful, including any one or more of those described herein.

Generally, the batter-like composition is mixed in large volume mixers and portioned on lines (typically, high-speed lines) forming individual product pieces (such as pucks) that can be optionally frozen and packaged, or packaged and refrigerated, to be baked at a later date. The batter-like compositions can be segregated into individual sized portions, referred to herein as intermediate products. The batter-like compositions can be mixed, for example, by batch or continuous processes. The intermediate products can be formed by portioning, sheeting, or extrusion processes as are known in the art.

In some aspects, the batter-like compositions described herein can be extruded using any appropriate extruder typically utilized for extruding dough. Extruders generally involve one or more screws that are rotated to propel the dough toward the die. The extruder can include sections with multiple screws and other sections with a single screw. If there is more than one screw, rotation of the screws mixes the dough as well as propels the dough forward. Generally, the screw is surrounded by a barrel that holds the dough under pressure as it moves toward the die. The extruder does not necessarily need a screw, and other implements such as paddles can be used to move the dough and to force the dough through the die under pressure. For example, conventional single screw food extruders or twin screw extruders can be used to mix and form intermediate products by extruding the batter-like compositions of the invention. Combination extruder devices that utilize single screw and twin screw components are also contemplated.

According to one known technique, the product pieces can be extruded from a die, cut to length, and deposited in rows on conveyors or continuous sheets of substrate (such as paper) in varying numbers depending upon the size of the pucks. Generally, these sheets are carried by conveyors and the pucks are subsequently frozen on the sheets, and the sheets can be cut for packaging. Generally, for the commercial consumer the frozen pucks can be packaged on the cut sheets as bulk product in cartons for sale to the customer. For the household consumer, it can be desirable to package the frozen pucks in smaller, more convenient packages, such as on paperboard and/or in a container (such as a muffin tray for pucks formulated to provide muffin products when baked). When it is desirable to store the pucks in a refrigerated format, the above methods can be followed, with substitution of refrigeration storage conditions for frozen.

Once the batter-like composition has been sufficiently formulated and mixed, the composition can be collected in a suitable collection device or hopper. Once a desired amount of batter-like composition has been collected, it can be fed to a supplying device to form the product pieces. Various devices can be used to form the individual product pieces, such as known or developed extruders, depositors, formers, and the like. Such extruders can include cutting wire or knife that passes beneath each die at repeated time intervals, thereby slicing off a short cylindrical (or otherwise shaped) segment of the batter-like composition, representing an individual product piece. As batter-like composition is extruded from a die, paper of indefinite length can be fed onto a conveyor belt that passes beneath the die. The belt can be raised close to the die to allow the batter-like composition to contact the paper and the height of the puck of batter-like composition is established. It is about the time the belt begins to be lowered from the highest position, that the wire or knife is passed through the batter-like composition to cut and form the individual puck. The cutting wire is lowered and retracted below the advancing batter-like composition in preparation for the next cut. The die can be arranged to cut a single puck of batter-like composition for each wire stroke, typically used in a lab development process, or, have many openings in a row to produce numerous pucks during each wire stroke.

One known machine that can be used to form pucks of the batter-like composition according to the invention is produced by APV Baker, Inc. of Goldsboro, N.C., and is known as a wire cut machine. Other machines and methods that can be used are described in commonly owned U.S. Pat. Nos. 6,715,518 (Finkowski et al., Apr. 6, 2004) and 6,561,235 (Finkowski et al., May 13, 2003), as well as U.S. Pat. No. 7,067,167 B1 (Damsgard, issued Jun. 27, 2006).

In still further embodiments, the product pieces can be formed in desired shapes, such as pucks, by compressing the batter into cavities in a die. In one embodiment, the product piece formation process is carried out in a continuous process system, whereby cavities in a rotary head are filled by batter-like composition to conform the batter-like composition to a desired shape. After the desired shape is obtained, the individual product pieces are released, ejected or discharged from the cavities by any suitable device, such as by a plunger, piston, air blast, or the like. After the product pieces are discharged from the cavities, the cavity is in one embodiment returned, optionally by rotation of a rotary head, to a position for initiation of a new filling cycle. The discharged pieces are conveyed to a packaging station in a conventional manner.

The intermediate products can either be filled or unfilled. In some embodiments, the extruder is fitted with a filling pump, such that batter-like composition reaching the die surrounds a filling and forms a coextrusion. Coextrusion is well known in the art. The relative amount of filling and batter-like composition can be adjusted by the relative speed of the extruder screw and the flow rate of the filling. When a filling is used, a structure of the batter-like composition surrounding the filling exits from the die during the extrusion process. The shape and size of the intermediate product depends on the shape and size of the die. The filled intermediate product can be cut or otherwise separated to a desired length. Once cut, the intermediate product can optionally be secured, for example by crimping, at one or both ends. Preferably the intermediate product is secured at both ends to seal the filling within the intermediate product.

In some aspects, the intermediate product pieces can be formed using extrusion dies conventionally utilized for extruding dough. One such extrusion die is described in U.S. Pat. No. 5,620,713 (Rasmussen, Apr. 15, 1997). As described therein, a die can include an inner die and an outer die. The inner die is formed in a desired shape that represents an item of interest, such as an animal, toy, or other identifiable object, and the outer die has an opening surrounding the inner die. The batter-like composition can be extruded through each of the dies simultaneously. The batter-like composition for the inner die can have a different indicia, such as color or other visually identifiable characteristic from the batter-like composition extruded through the outer die.

In an alternative embodiment, the batter-like composition portion of the intermediate product can be extruded to create a first intermediate piece for subsequent deposition of a filling thereon. The filling on the first intermediate piece is then optionally enclosed by folding the first intermediate piece or laminating the filling on the first intermediate piece with a second intermediate piece, followed by securing the intermediate pieces together, for example by crimping or the like, to seal the filling inside the intermediate product.

The filling, if any, can be a raw or cooked food product. The filling can have a uniform consistency or a chunky consistency. In some embodiments, the filling is a highly viscous liquid, suspension or pseudoliquid, for example, a flowable mixture of particulates and/or liquid that may not normally be a liquid or a suspension. In some aspects, the material is highly viscous such that it will not flow immediately through any imperfection in a covering formed by the batter-like composition or out from the ends of seams of the intermediate product when cut and crimped after exiting the extruder.

The filling can be made from any type or types of food ingredients, including savory or sweet ingredients. Examples of savory ingredients include but are not limited to meat, vegetable, and dairy ingredients. Examples of sweet ingredients include but are not limited to fruit or icing ingredients. Both savory and sweet ingredients may further include spices, herbs, flavoring agents, fats, and the like. The filling can further include such ingredients as preservatives and consistency modifiers such as emulsifiers and thickening agents.

In some aspects, the batter like composition can be sheeted to provide intermediate products as discrete units. Batter-like compositions can be handled in individual pieces for example, or as a continuous sheet. The batter-like compositions can be sheeted on a continuous or reversible sheeter, as are well known in baking arts. Sheeting can be utilized to provide the batter-like composition with a suitable thickness, which can depend upon such factors as the desired size and/or configuration of the intermediate product, the final baked goods to be prepared from the compositions, and the like. After completion of sheeting, the batter-like composition can be rolled and/or shaped to provide the intermediate product.

The above-described equipment and methods for forming the pieces are known in the baking arts for forming conventional bread doughs and cookie doughs. In some aspects, it can be advantageous that these known techniques can be applied for the inventive batter-like compositions, since existing equipment can be utilized to prepare the inventive compositions and products.

Typically, intermediate products comprising individual pieces are from about 0.5 ounces to about 4 ounces in weight, or about 2 ounces in weight. Embodiments of pucks according to the invention are provided in frozen or refrigerated form, and packaged for shipping to the consumer. In some embodiments, the individual products are provided as freezer-to-oven batter-like products, where the consumer does not have to thaw the batter-like products prior to placing the product pieces into the oven for baking. In these embodiments, the consumer can simply remove the product pieces from the freezer, place the pieces in or on a suitable baking utensil (such as a baking sheet, pan, tray and the like), and place the baking utensil containing product pieces directly into the oven. These embodiments can provide advantageous time savings to the consumer, who does not have to thaw the individual product pieces prior to baking.

Advantageously, intermediate products in accordance with the invention do not require baking utensils that provide side containment of the batter-like composition as it is baking. Thus, in some aspects, the inventive intermediate products can be placed on a baking tray or other utensil lacking side containment. The intermediate products of the invention can retain their discrete shape above storage temperatures and up to baking temperatures. At baking temperatures, the intermediate products can bake up into a suitable baked good, such as a muffin, without requiring additional structural support from the baking utensil. Thus, a wide variety of baking utensils can be utilized to prepare baked goods with the intermediate products, since the products do not require, for example, muffin tins or the like to retain shape upon baking.

In some aspects, the batter-like compositions of the invention can be particularly advantageous. For example, the inventive compositions as described herein can provide superior handling properties both for the manipulation steps required of the manufacturer for placing the batter-like compositions in the various formats as described herein, and at the same time for manipulation of the product pieces by the intermediate consumer who will bake the batter-like compositions. The consumer who will bake the batter-like compositions can prepare a wide variety of flavors of product. For example, in some aspects, the consumer can combine intermediate products that include a selected type of flavoring agent and/or inclusion (for example, blueberry) and intermediate products that include a different selected type of flavoring agent and/or inclusion (for example, cranberry). In one such illustrative embodiment, one or more blueberry intermediate products can be placed adjacent one or more cranberry intermediate products, thereby providing, upon baking, a blueberry/cranberry flavored baked good.

In other aspects, the end consumer can be provided with a fresher product as compared to goods (such as muffins) that are baked prior to packaging. For example, in-house bakery services, such as those found in some large grocery stores, can easily prepare batches of muffins throughout the day, each time removing and baking only the desired portions for the batch, and returning any unused portions to storages (refrigerated or frozen).

The invention can also provide significant advantages to in-house bakeries. For example, the intermediate products described herein can be packaged such that they take up less storage space in the refrigerator or freezer. Given the relatively compact portion size of the intermediate products, the inventive compositions and systems provide significant flexibility in terms of packaging format. Moreover, the inventive compositions and systems can generate less wasted product as compared to prior art compositions. For example, prior scoopable or pourable batters that are packaged in large containers (such as pails or tubs) have limited storage stability after the packaging has been opened. As a result, once the container has been opened, the consumer has a number of days to utilize the batters before spoilage. Further, the pail/tub formats can often result in residual batter that remains in the container (for example, at the periphery of the container) that is difficult to retrieve from the container and therefore often spoils and/or dries out before it can be utilized to prepare baked products.

Additionally, some embodiments of the batter-like compositions can provide excellent water activity, storage stability, and density properties of the batter-like compositions in frozen or refrigerated form throughout the distribution chain.

In some method aspects, the invention provides methods of preparing finished baked goods from the inventive batter-like compositions. Conveniently, the inventive batter-like compositions are prepared into finished baked goods by simple removal of the product pieces from storage (frozen or refrigerated) and placement in suitable baking conditions to form a finished baked good. The inventive product pieces are provided in convenient portions (for example, 2-ounce portions) that can be removed from storage and simply baked for sufficient times to form a finished baked good. In some aspects, the batter-like compositions do not require any manipulation by the consumer, such as scooping or otherwise portioning the batter-like compositions for baking. If the consumer desires to prepare a baked good that requires more than the particular sized portion (such as a 2-ounce portion), the consumer can simply place more than one product piece in an adjacent manner in the baking utensil (baking sheet, pan, and the like), and place the product pieces in the baking environment.

One or more advantages can be provided by the inventive batter-like compositions. For example, as described immediately above, the batter-like compositions do not require manipulation of the batter-like composition for preparation of baked goods. The discrete physical form of the product pieces can provide a product that is easier to handle and less likely to spill or otherwise deform during handling. Further, unused portions of the batter-like composition after partial use can be conveniently returned to frozen or refrigerated storage, to be used at a later time. In some aspects, the product pieces can be immediately placed into the baking container without need for allowing the batter-like composition to thaw. If desired, however, the batter-like composition can be allowed to rest or thaw for shorter times relative to conventional batters, without serious adverse effect.

The invention can, in some aspects, provide significant benefits in terms of handling and storage, while also providing a baked product that is comparable to baked products prepared using conventional techniques (such as fresh batter preparation). The baked products can be comparable in terms of product attributes such as texture, mouthfeel, moistness, and specific volume. In some aspects, the batter-like compositions can be used to prepare baked goods having baked specific volume (BSV) for muffins of about 1.8 to about 2.2 cc/g, or about 2 cc/g.

While the invention is specifically described in terms of improved baked goods, such as layer cakes, muffins, quick breads, cupcakes, biscuits, corn breads, and the like, the batter-like compositions can be used for or formulated for use to prepare other cooked farinaceous goods within the scope of the invention, including griddle cakes such as pancakes, crepes, or cornbreads, Irish soda breads or waffles. Also, while the present articles are especially suited for use in preparing leavened finished goods, other finished goods can also be prepared therefrom.

The invention will now be described with reference to the following non-limiting examples.

### EXAMPLES

### Preparations

For the preparations described in these Examples, bench top samples were prepared and evaluated. Unless specifically stated otherwise, reference to a mixer and mixing steps for preparation of the batter-like composition refer to a Kitchen Aid standard countertop mixer, the stated speeds based upon speeds of the mixer used.

### Sample 1: Muffin Pucks Batter-Like Composition According to One Embodiment of the Invention

| Formula | Ingredient | Formula % |
|---|---|---|
| Gum/hydrocolloid solution | Water | 88.4 |
| | Gums/hydrocolloids | 0.9 |
| | Oil | 8.8 |
| | Emulsifier | 0.9 |
| | Starch | 0.9 |
| | Preservatives | 0.1 |
| | Total | 100 |
| Emulsion | Emulsifier | 13.4 |
| | Fat component | 44.6 |
| | Water | 41.8 |
| | Gum/hydrocolloid solution | 0.2 |
| | Total | 100 |
| Batter-like Base (dry) | Flour (with enrichment) | 42.5 |
| | Whey solids | 2 |
| | Leavening | 1.1 |
| | Minors | 4.5 |
| | Sugar | 47 |
| | Oil | 3 |
| | Total | 100 |

### Process

1. A portion of the emulsifiers, oil, and shortening were combined. The combination was mixed and heated to a temperature in the range of 100° F. to 250° F. (37.8° C. to 121.1° C.) to melt solid fat component.
2. Water and gum/hydrocolloid solution were combined. The combination was mixed and heated to a temperature in the range of 100° F. to 250° F. (37.8° C. to 121.1° C.).
3. Remaining emulsifiers were combined, followed by combination with #1 and #2 at a temperature of 130° F. to 210° F. (54.4° C. to 98.9° C.) with mixing at high sheer until emulsion was formed (whip in Kitchen Aid mixer on Level 6 for 10 minutes using whisk attachment). The resulting emulsion exhibited a temperature of 50° F. to 200° F. (10° C. to 93.3° C.).
4. The emulsion was cooled at refrigeration temperatures (42° F. (5.6° C.)) for 2 hours.
5. The ingredients for the dry mix were combined. Water was added to the dry mix to provide batter-like base. The resulting mixture was mixed for one minute at low speed, followed by one minute at high speed using paddle attachment in Kitchen Aid mixer. Next, starch and flavors were added with mixing.
6. The combination of Step #5 was combined with egg component. The combination was mixed for one minute on low speed, followed by three minutes on high speed using paddle attachment in Kitchen Aid mixer.
7. The combination of Step #6 was combined with the emulsion formed in #4. This mixture was mixed for one minute at low speed, followed by three minutes at high speed using paddle attachment in Kitchen Aid mixer.
8. Blueberries were added to the combination formed in Step #7, followed by mixing 30 seconds on high using paddle attachment in Kitchen Aid mixer.

### Sample 1 Overall Batter-Like Composition:

| Ingredient | Formula % |
|---|---|
| Water | 1.3 |
| Batter-like base (dry) | 47.7 |
| Starch | 0.9 |
| Flavors | 0.2 |
| Egg component | 16.7 |
| Emulsion | 25 |
| Blueberries | 8 |
| Total | 100 |

### Sample 2: Scoopable Batter (Comparative #1)

| Formula | Ingredient | Formula % |
|---|---|---|
| Stage 1 | High Maltose Syrup | 23.9 |
| | Edible oil | 10.2 |
| | Water | 8.5 |
| | Egg component | 6 |
| | Humectant | 5.1 |
| | Sucralose | 0.09 |
| Stage 2 | Flour | 23.8 |
| | Sugar | 3.4 |
| | Starch | 1.7 |
| | Salt | 0.6 |
| | Chemical leavening system | 2 |
| Stage 3 | Blueberries | 14.9 |
| | Total | 100 |

### Process

1. Stage 1 ingredients were combined and mixed for 2 minutes on low using paddle attachment in Kitchen Aid mixer.
2. The combination formed in Step #1 was combined with Stage 2 ingredients and mixed 2-3 minutes more on low until lumps are gone, using paddle attachment on Kitchen Aid mixer.
3. Stage 3 ingredients were added, and the resulting combination was mixed for 30 seconds on low using paddle attachment on Kitchen Aid mixer.

### Sample 3: Batter (Comparative #2)

| Formula | Ingredient | Formula % |
|---|---|---|
| Muffin Base | Flour (with enrichment) | 41.3 |
| | Chemical leavening | 1 |
| | Emulsifiers | 2.5 |
| | Minors | 3.3 |
| | Sugar | 45.7 |
| | Starch | 3 |
| | Oil | 3 |
| | Gums | 0.2 |
| | Total | 100 |
| Muffin Batter | Muffin Base | 46.2 |
| | Flavors | 0.2 |
| | Egg component | 16 |
| | Oil | 13.7 |
| | Water | 10 |
| | Blueberries | 13.9 |
| | Total | 100 |

### Process

1. Muffin base was prepared as follows. Minor hand weight ingredients were weighed and added into a dry mixer. Bulk scaled ingredients were then added to the dry mixer. The dry mixer automatically ran while ingredients were being added. Ingredients were transferred to a wet mixer. When the transfer was complete, fats, oils, and emulsifiers were added (by spray or pump) to the wet mixer. The spray rate was 1.7 pounds per second. Mixing was continued after completion of fat and emulsifier addition. Total mixing time was 12 minutes.
2. The prepared Muffin Base was then combined with flavors, egg component, oil, and water. Water temperature was maintained at 110° to 120° F. (43.3° C. to 48.9° C.). Ingredients were mixed for 5 minutes on high in a Shaffer Twin Sigma Mixer.
3. Cultivated blueberries were added to #1 and mixed for 5 seconds on high in the same mixer.

### Sample 4: Scoopable Sweet Dough (Comparative #3)

| Ingredient | Formula % |
|---|---|
| Flour (with enrichment) | 34 |
| Humectant | 36 |
| Leavening system | 20.5 |
| Shortening | 2 |
| Minors | 7 |
| Water | to achieve dough consistency |

### Process

1. All dry ingredients (flour, shortening, solid humectant, protein supplements, leavening system) were blended in a Horizontal Bar mixer equipped with a jacketed glycol coolant. The ingredients were blended at a speed of about 32 to 40 rpm for about 30 seconds.
2. The liquid ingredients (water, flavors, liquid humectants) were added. The liquid and dry ingredients were then mixed for 3.5 minutes at low speed.
3. Additional water was added to achieve a desired dough consistency (flour-to-water ratio was in the range of 2:1 to 1:1), and mixing was continued at high speed for an additional 2 minutes.

### Evaluations

Various Theological properties of the prepared samples (Samples 1-4) were observed as follows. Each sample was analyzed for composition resistance (farinograph), texture, stiffness, pH, water activity, and moisture content.

### Farinograph

Generally, batter consistency can be determined by a Farinograph measurement. A Farinograph measurement measures a composition's resistance to mixing.

Samples were prepared as described in Samples 1, 2, 3 and 4. All samples were evaluated at a temperature in the range of 35° F. to 45° F. (1.7° C. to 7.2° C.). For the Farinograph measurement, a 450 g sample of each formulation described in Samples 1-4 was placed in a jacketed bowl, which was at a temperature of 40° F. (4.4° C.), equipped with a sigma blade (C.W. Brabender Instruments, Inc., South Hackensack, N.J.). The sample was placed in a Farinograph and measurements were taken for a time period effective for determining peak amplitude.

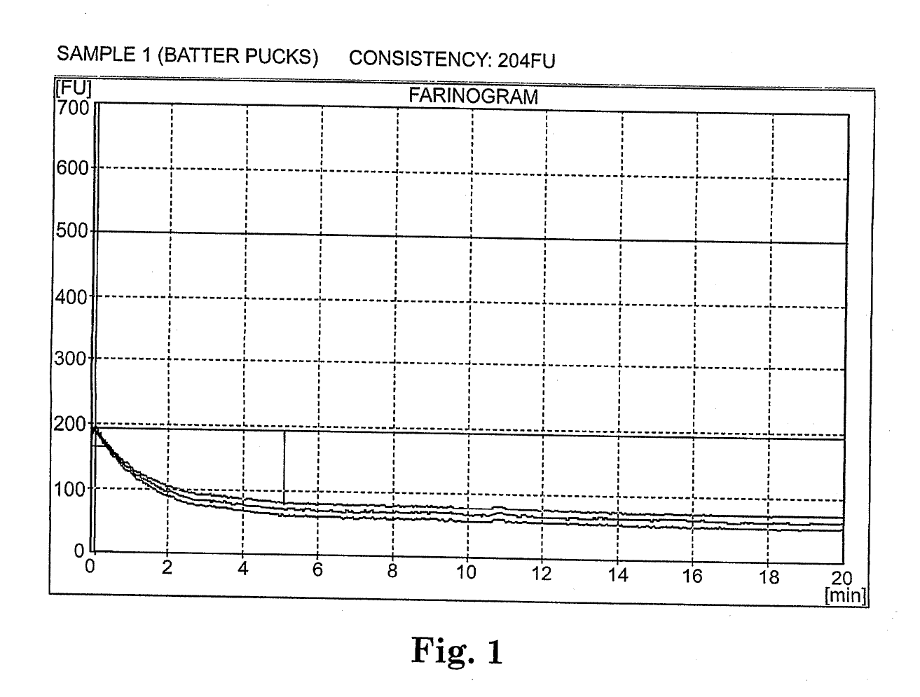

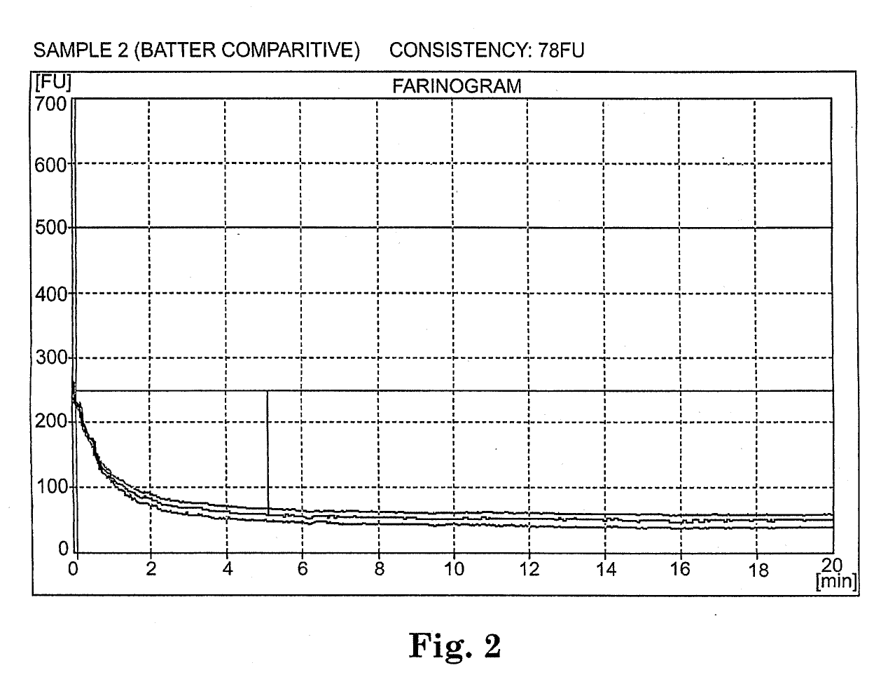

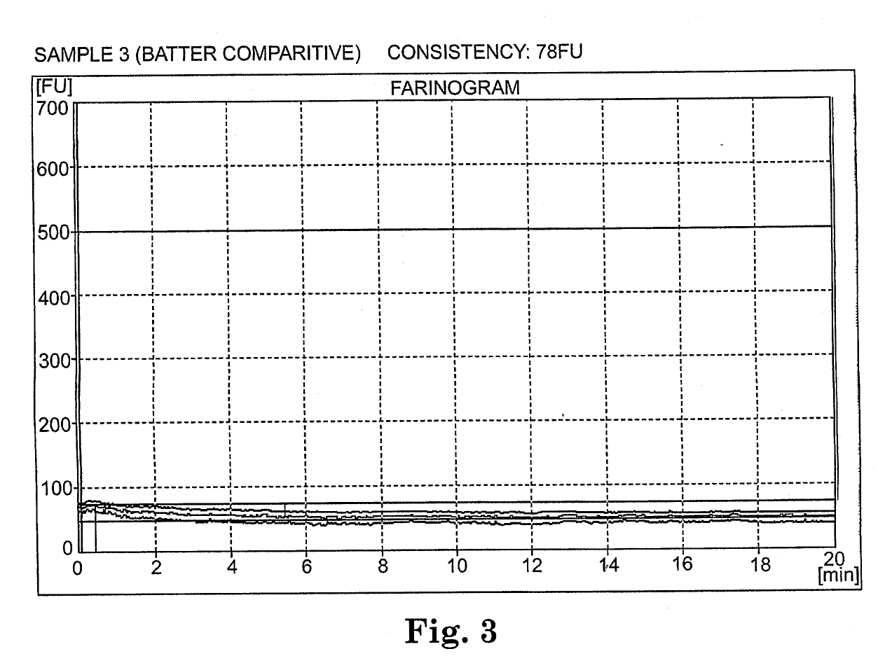

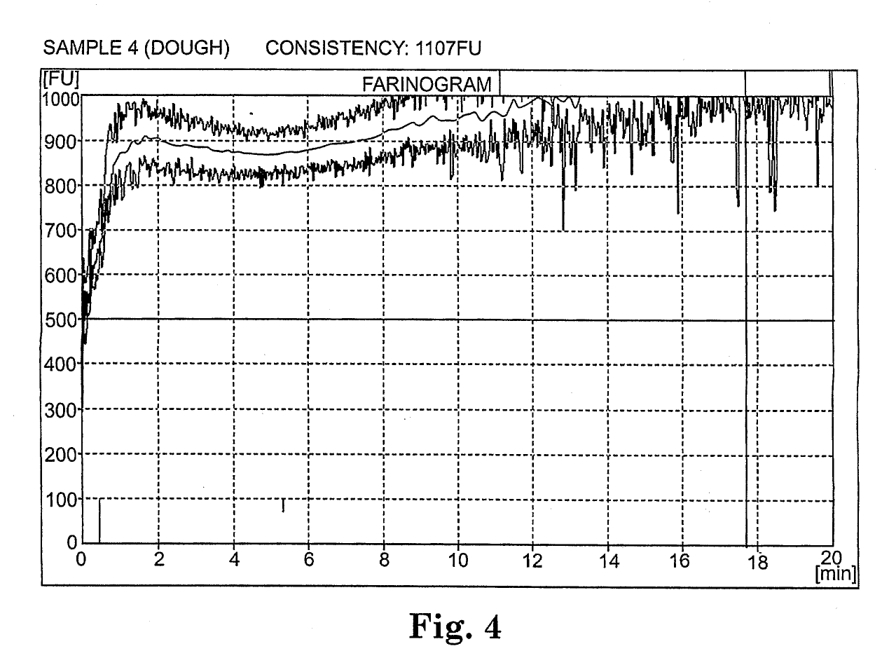

The Farinograph was operated according to manufacturer's instructions. The peak amplitude was identified and recorded. The peak amplitude provides the dough consistency. Samples were run for 20 minutes. Results are shown in Table 1 below and are given in farinogram units (FU). Results are also illustrated in FIGS. 1-4.

TABLE 1
Consistency

| | |
|---|---|
| Sample 1 | 204 FU |
| Sample 2 | 78 FU |
| Sample 3 | 74 FU |
| Sample 4 | 1107 FU |

Results demonstrated that Sample 1, prepared in accordance with one embodiment of the invention, demonstrated superior consistency when compared to Samples 2 and 3. Samples 2 and 3 demonstrated comparable consistency to each other. Inclusion of the inventive emulsions according to some embodiments of the invention thus provides improved consistency as compared to conventional batters. Sample 4, representing a conventional dough composition, exhibited a much higher consistency relative to the inventive composition. This demonstrates the unique nature of the inventive compositions—an intermediate resistance to mixing was observed for the sample prepared in accordance with an aspect of the invention. The invention thus provides a novel product category that is distinct from both conventional batters and doughs, yet can provide baked goods comparable to those prepared from conventional batters.

### Texture Analysis

Texture analysis of each of the samples prepared in Samples 1-4 was measured utilizing a TA.XT Plus texture analyzer (Texture Technologies Corp., Scarsdale, N.Y.). Procedures for testing texture of batter samples are provided by the American Institute of Baking (AIB), Manhattan, Kans. Three runs of each sample were prepared. Sample size was 10 grams for each. Tests were run according to manufacturer instructions.

Samples were placed in the plastic box of the texture analyzer. The samples were compressed by lowering the equipment probe to a level of 57 mm. The probe speed was as follows: pre-test 1 mm/second, test 3 mm/second, post-test 10 mm/second. Force measurements were taken at the time point when the probe was initially lowered, then again after the probe was held in the lowered position.

The test was carried out under nitrogen atmosphere to control temperature (temperature maintained at approximately 0° F. (−17.8° C.)). The amount of force to compress the sample was measured and correlated to the hardness of the sample.

In addition to sample hardness, the spreadability of the sample was also determined. The spread of the product when compressed was correlated to the sample's viscosity.

Results are illustrated in Table 2 below, where spread is represented as area under the curve, and hardness is represented as force.

TABLE 2
Sample spread and hardness

| | Spread | |
|---|---|---|
| Sample | (kg/second) | Hardness (kg) |
| Sample 1 | 8.044 | 13.828 |
| Sample 2 | 5.546 | 12.08 |
| Sample 3 | 2.244 | 5.858 |
| Sample 4 | 74.475 | 56.02 |

Results illustrate that Sample 1, prepared in accordance with some aspects of the invention, provided a superior spread and hardness, as compared to the samples prepared in accordance with known formulations and methods. More specifically, the batter-like composition of Sample 1 demonstrated a larger area of spread than both batters prepared as described for Sample 2 and Sample 3. The batter-like composition of Sample 1 required more force (almost 14 grams, as compared to approximately 12 and 6 grams of force) to compress the sample than the samples prepared in accordance with formulations and methods outside the invention. Samples prepared in accordance with the invention thus provided a harder composition as compared with samples that lacked the inventive emulsion system. Results illustrated that Sample 4 showed the greatest amount of spread but it also required the most force to compress. The dough is different from the batter products because it requires much more force to compress.

### Dynamic Mechanical Analysis (DMA)

The sample stiffness and loss of sample stiffness were measured for each of Samples 1-4 utilizing the Dynamic Mechanical Analysis (DMA) test. Generally, the sample stiffness depends upon its modulus of elasticity and its geometry or shape. The modulus is defined as the stress per unit area divided by the strain resulting from an applied force. Dynamic mechanical testers apply a periodic stress or strain to a sample and measure the resulting strain or stress response of the sample. DMA thus provides a measure of a material's resistance to deformation. The higher the modulus, the more rigid the material is.

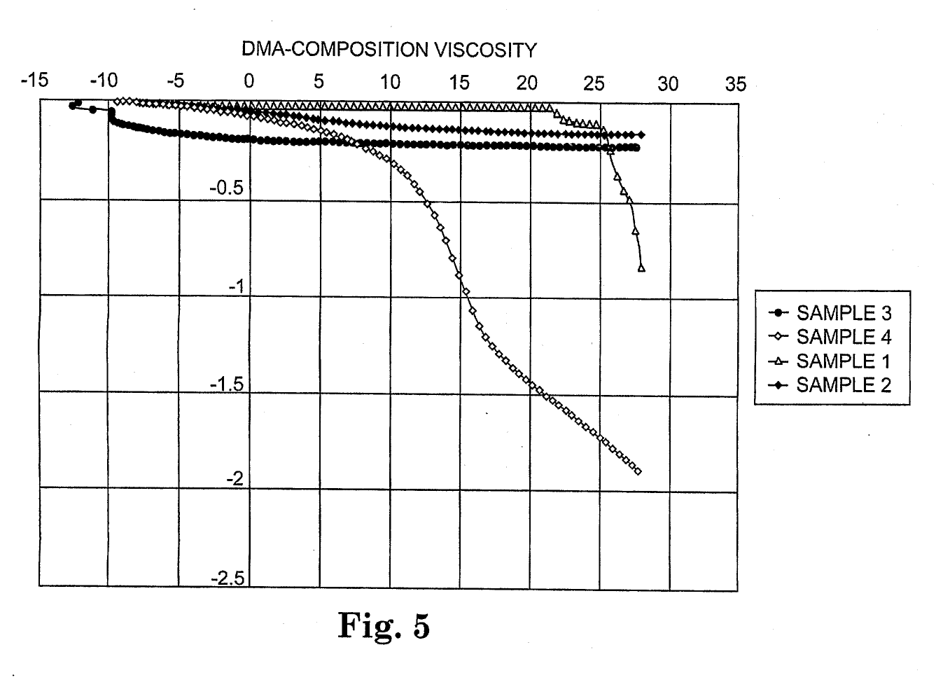

For each sample, DMA testing was carried out under controlled temperature (in the range of 14° F. to 86° F. (−10° C. to 30° C.)). Differences of viscosity among Samples 1-4 are shown in FIG. 5, where probe position is represented on the Y-axis, and temperature (° C.) is represented on the X-axis. Each sample size was 1 gram of raw batter or dough.

Results indicate that samples prepared in accordance with some aspects the invention exhibit a higher resistance to deformation. Sample 1 was more stiff (harder) than Samples 2-4, demonstrated by resistance to compression by the probe during testing. Moreover, Sample 1 was more robust than Samples 2-4, demonstrated by continued resistance to deformation during testing and temperature elevation. Once a temperature threshold was reached for the Sample 1 (between 68° F. and 77° F. (20° C. and 25° C.)), the product exhibited a change in viscosity. This illustrates the ability of batter-like compositions in accordance with the invention to maintain non-flowable properties to a desired temperature threshold. Upon reaching a selected temperature threshold, the inventive compositions can exhibit a phase change, wherein the compositions become flowable (and thus more capable of deformation). At this more flowable phase, the inventive compositions behave more like traditional batters (see results).

Again, the inventive compositions can be contrasted with both conventional batters and conventional doughs. Results for Sample 4 illustrate that a dough composition exhibited a lower temperature threshold (between 32° F. and 41° F. (0° C. and 5° C.)) than the batter-like composition of Sample 1. Additionally, once this temperature threshold was reached (between 32° F. and 41° F. (0° C. and 5° C.)), the dough exhibited a more gradual change in viscosity. The shape of the curve for Sample 4 illustrates a more gradual slope than the curve for Sample 1.

Results demonstrate compositions prepared in accordance with the invention can provide non-flowable intermediate products that exhibit superior robustness relative to other known batter or dough compositions. Such product robustness can provide improved ease of handling for operator during baking/preparation of baked products.

### pH Analysis

The pH of the samples prepared in Samples 1-4 was determined. Generally, a lower batter pH will weaken gluten and can provide antimicrobial effects to a batter composition. Typically, it is desirable to obtain batters that are not highly acidified and range in pH from about 6.0 to about 8.5. The pH of the sample prepared in accordance with some embodiments of the invention was comparable to traditional batters. Differences in pH of the samples tested can be affected, at least in part, by any particulates included (in these cases, blueberry particulates were included, which can impact pH).

For observation of pH levels, an Accumet pH meter available from Fisher Scientific was used. For these measurements, 3 runs of each sample were made. All samples were maintained at a temperature of about 32° F. (0° C.), such that samples were slightly thawed and the pH meter electrode could be introduced in the sample. For the sweet dough sample (Sample 4, comparative #3), the dough was prepared in a 10% distilled water (diH₂O) solution, to allow the introduction of the pH meter electrode. Results are illustrated in Table 3 below.

TABLE 3
pH measurements

| Sample | pH |
|---|---|
| Sample 1 | 7.39 |
| Sample 2 | 6.92 |
| Sample 3 | 7.14 |
| Sample 4 | 7.88 |

Results illustrate that the sample of Sample 1, prepared in accordance with one embodiment of the invention, provided a neutral pH level. As mentioned herein, inclusion of particulates (in these instances, blueberries) can impact pH levels. Differences between the pH levels of Samples 1-4 were considered negligible. Results for pH measurements were duplicated in parallel experiments.

### Water Activity

Water activity instruments measure the amount of free (also referred to as unbound or active) water present in a sample. A portion of the total water content present in a product is strongly bound to specific sites on the chemicals that comprise the product. The water activity of a product can be determined from the relative humidity of air surrounding the sample when the air and the sample are at equilibrium. Therefore, the sample is typically provided in an enclosed space where this equilibrium can take place. Once this occurs, the water activity of the sample and the relative humidity of the air are equal. The measurement taken at equilibrium is referred to as the equilibrium relative humidity (ERH).

For the Samples, water activity was measured utilizing an AquaLab water activity meter (Decagon Devices, Inc., Pullman, Wash.). Samples of product prepared in accordance with Samples 1-4 were placed in the sample cup provided with the equipment, in accordance with manufacturer's instructions. Samples were placed within the sealed chamber of the water activity meter. The sample was equilibrated within the headspace of the sealed chamber. Both the dew point and the sample temperatures were measured and utilized to determine the water activity.

Three runs of each sample were made. Results are summarized in Table 4 below. Results were consistent with the water percentages for each formula.

TABLE 4
Water activity of samples

| Sample | Aw |
|---|---|
| Sample 1 | 0.923 |
| Sample 2 | 0.845 |
| Sample 3 | 0.929 |
| Sample 4 | 0.941 |

Results were consistent with the water percentages of each formula. Results indicate that batter-like compositions formulated in accordance with one embodiment of the invention provide a water activity that is intermediate to the water activity levels of batters prepared as a scoopable product (Sample 2) and batters prepared in a pail format (Sample 3). Batter-like compositions according to some embodiments of the invention can be baked to provide baked products having a good moisture content and desirable mouthfeel. Results for water activity measurements were duplicated in parallel experiments.

### Moisture Content

The moisture content of the Samples was performed by oven drying in a vacuum oven at 158° F. (70° C.) for 16 hours. Observed moisture content was as follows:

TABLE 5
Moisture Content.

| | |
|---|---|
| Sample 1 | 37.2% |
| Sample 2 | 36.1% |
| Sample 3 | 38.7% |
| Sample 4 | 33.0% |

Results illustrate that Sample 1, prepared in accordance with some embodiments of the invention, exhibits a comparable moisture content to conventional batters and doughs.

### Density and Baked Specific Volume (BSV)

The density of the compositions prepared in accordance with Samples 1-4 were measured. Densities were taken using a standardized density cup with a volume of 207 ml. The density for each sample was as follows:

TABLE 6
Density.

| | |
|---|---|
| Sample 1 | 1.056 g/cc |
| Sample 2 | 1.177 g/cc |
| Sample 3 | 1.112 g/cc |
| Sample 4 | 1.179 g/cc |

In addition to the above, cake and pancake batter-like compositions were formulated according to the inventive formulations for the batter-like compositions herein.

TABLE 7
Density.

| | |
|---|---|
| Yellow Cake batter-like composition | 0.780 g/cc |
| White cake batter-like composition | 0.798 g/cc |
| Pancake batter-like composition | 1.038 g/cc |

Six samples were prepared according to Sample 1 formulation and process described above. The resulting batter-like compositions were formed into discrete intermediate products (pucks) and baked. The BSV for the samples was collected using a volume measuring instrument from TexVol Instruments AB (Sweden). Results were as follows:

TABLE 8
BSV.

| Sample | Weight (g) | BSV (g/cc) |
|---|---|---|
| Sample 1a | 120 | 1.927 |
| Sample 1b | 104.44 | 2.169 |
| Sample 1c | 107 | 2.104 |
| Sample 1d | 120 | 2.132 |
| Sample 1e | 101.75 | 2.193 |
| Sample 1f | 108.07 | 2.178 |
| Average | | 2.12 |

### Water Absorption Values (Calculated)

Calculated water absorption for each of Samples 1-4 (relationship of water added to dry materials in the product: H₂O/dry matter=Absorption) was as follows:

TABLE 9
Water absorption.

| | |
|---|---|
| Sample 1 | 52.96% |
| Sample 2 | 59.52% |
| Sample 3 | 47.14% |
| Sample 4 | 37.55% |

Calculated water absorption illustrates that absorption level of batter-like compositions in accordance with the invention can be comparable to that of convention batters. At the same time, however, conventional batters are typically flowable and capable of deformation (as discussed herein). In contrast, the inventive batter-like compositions provide the ability to form discrete, non-flowable intermediate products.

Generally speaking, water is tied up differently in the inventive compositions, as compared to conventional batters or doughs. As discussed herein, water can be tied up in an emulsion that is provided as a component of the inventive compositions. Thus, the batter-like compositions can form intermediate products that are non-flowable as described herein. At the same time, the batter-like compositions can free up water at critical points during a baking cycle, thereby allowing the batter-like systems to perform similar to conventional batters during baking.

Other embodiments of this invention will be apparent to those skilled in the art upon consideration of this specification or from practice of the invention disclosed herein. Variations on the embodiments described herein will become apparent to those of skill in the relevant arts upon reading this description. The inventors expect those of skill to use such variations as appropriate, and intend to the invention to be practiced otherwise than specifically described herein. Accordingly, the invention includes all modifications and equivalents of the subject matter recited in the claims as permitted by applicable law. Moreover, any combination of the above-described elements in all possible variations thereof is encompassed by the invention unless otherwise indicated. All patents, patent documents, and publications cited herein are hereby incorporated by reference as if individually incorporated. In case of conflict, the present specification, including definitions, will control.

We claim:

1. A method of preparing a batter-like composition comprising steps of:
(a) combining a fat source and water;
(b) heating and mixing the fat source and water to provide an emulsion;
(c) cooling the emulsion to a temperature in the range of about 40° F. to about 200° F. (4.4° C. to about 93.3° C.); and
(d) combining the emulsion with a batter-like base comprising flour or flour replacement ingredient, sweetener, and water to form a batter-like composition having a water activity of less than about 0.94.

2. The method according to claim 1 wherein step (a) further comprises adding one or more anti-sticking agents.

3. The method according to claim 1 wherein step (a) further comprises adding emulsifiers.

4. The method according to claim 1 wherein step (a) further comprises adding starch.

5. The method according to claim 1 wherein step (d) further comprises adding chemical leavening agent.

6. The method according to claim 5 wherein the chemical leavening agent is encapsulated.

7. The method according to claim 1 wherein step (d) further comprises adding a fat source.

8. A batter-like composition prepared in accordance with the method of claim 1.

9. A method for preparing an intermediate farinaceous product comprising steps of:
(a) combining a fat source and water;
(b) heating and mixing the fat source and water to provide an emulsion;
(c) cooling the emulsion to a temperature in the range of about 40° F. to about 200° F. (4.4° C. to about 93.3° C.);
(d) combining the emulsion with a batter-like base comprising flour or flour replacement ingredient, sweetener, and water to provide a batter-like composition having a total moisture content in the range of about 20% to about 40%; and
(e) forming the batter-like composition into discrete, non-flowable product units.

10. The method according to claim 9 wherein step (e) comprises forming the batter-like composition into units having a consistency in the range of about 100 FU to about 1100 FU, when the batter-like composition is at temperatures below about 42° F. (5.6° C.), and a consistency of less than about 100 FU when heated to temperatures above about 42° F. (5.6° C.).

11. The method according to claim 9 wherein step (e) comprises forming the batter-like composition into units having a hardness above about 2 kg at temperatures in the range of about −10° F. to about 30° F. (−23.3° C. to about −1.1° C.).

12. The method according to claim 9 wherein step (e) comprises forming the batter-like composition into units having a spreadability above about 5 kg/s at temperatures in the range of about −10° F. to about 30° F. (−23.3° C. to about −1.1° C.).

13. An intermediate farinaceous product prepared in accordance with the method of claim 9.

14. A packaged farinaceous product comprising:
(a) a package comprising a plurality of material sheets contained within a package design; and
(b) a plurality of individual farinaceous products of claim 13 positioned on each material sheet.

15. A batter-like composition comprising:
(a) a structure providing amount of flour or flour replacement ingredient;
(b) sweetener in an amount effective to provide a water activity of less than about 0.94;
(c) fat source; and
(d) a chemical leavening system,
wherein the batter-like composition retains its original discrete shape at temperatures above about 42° F. (5.6° C.), and
wherein the batter-like composition includes less than about 0.4% gelatin.

16. The batter-like composition according to claim 15 comprising a structure providing amount of flour replacement ingredient, the flour replacement ingredient comprising native starch in an amount of about 70% by weight or more, and a protein source in an amount of about 30% by weight or less, weight percentages based upon weight of the flour replacement ingredient.

17. The batter-like composition according to claim 16 wherein the native starch comprises wheat starch, corn starch, potato starch, tapioca starch or a combination of any of these.

18. The batter-like composition according to claim 16 wherein the protein source comprises gluten, wheat protein, soya protein, sodium caseinate, milk protein, whey protein, or a combination of any of these.

19. The batter-like composition according to claim 16 wherein the flour replacement ingredient further comprises a fiber source.

20. A batter-like composition comprising:
(a) a structure providing amount of flour or flour replacement ingredient;
(b) sweetener in an amount effective to provide a water activity of less than about 0.94;
(c) fat source; and
(d) a chemical leavening system,
wherein the batter-like composition retains its original discrete shape at temperatures above about 42° F. (5.6° C.), and
wherein the chemical leavening system comprises dimagnesium phosphate trihydrate as a major acidic leavening agent, in combination with a basic leavening agent.

21. The batter-like composition according to claim 20 wherein dimagnesium phosphate trihydrate comprises at least about 75% by weight of the acidic leavening agent.
